(19) United States
(12) Patent Application Publication
(10) Pub. No.: US 2024/0377806 A1
(43) Pub. Date: Nov. 14, 2024

(54) METHODS, SYSTEMS, AND APPARATUSES FOR USER DEVICE REPAIR AND CONDITIONING

(71) Applicant: ASSURANT, INC., New York, NY (US)

(72) Inventors: Jason KUTZ, York Springs, PA (US); Jeremy SHERIFF, Dillsburg, PA (US); Joshua SHEFFER, York, PA (US); Christopher SURRATT, Mount Wolf, PA (US); Omer HIKMAT, York, PA (US); David M. STOY, JR., Mount Joy, PA (US)

(21) Appl. No.: 18/315,036

(22) Filed: May 10, 2023

(51) Int. Cl. G05B 19/4061

(52) U.S. Cl. CPC G05B 19/4061; G05B 2219/45238

(57) ABSTRACT

Methods, apparatuses, systems, computing devices, and/or the like are provided. In some embodiments, an example system for conditioning a user device may include a handling device including an end effector, wherein the handling device is configured to operably engage the user device with the end effector and deliver the user device to an apparatus for conditioning the user device selected from a group of apparatuses for conditioning the user device, the apparatus for conditioning the user device comprising a platform configured to support the user device; a conditioning device configured to engage a tool comprising a tool head; a dispenser assembly comprising an actuatable reservoir and compound pot, wherein the actuatable reservoir is fluidically coupled with the compound pot to dispense a conditioning compound therein; a positioning assembly configured to move the conditioning device relative to the user device and the compound pot; and at least one non-transitory computer-readable medium.

### TECHNICAL FIELD

The present disclosure relates generally to repairing and conditioning user devices, such as smart phones. More specifically, this disclosure relates to automated mechanisms and processes for conditioning the surfaces of mobile phone devices.

### BACKGROUND

For user devices (e.g., smart phones), customers and businesses are increasingly looking to prolong the lifespan of such devices. In some such embodiments, it may be desirable to refurbish and/or repair a user device that may be functional but externally damaged or otherwise worn. Existing solutions for improving the external condition of a user device are labor intensive, may vary in quality depending on the repairer's experience, and may require high maintenance and supply replenishment. Additionally, highly automated aqueous solutions for repairing a user device's cosmetic exterior may be large, expensive, and may require strict and costly environmental controls.

Through applied effort, ingenuity, and innovation, Applicant has solved problems relating to the repair and conditioning of user devices by developing solutions embodied in the present disclosure, which are described in detail below.

### SUMMARY

In general, aspects of the present disclosure provide methods, apparatuses, systems, computing devices, computing entities, and/or the like.

Various embodiments of the present disclosure may include an apparatus for conditioning at least one surface of a user device. In some embodiments, the apparatus includes a platform configured to support the user device; a conditioning device configured to engage a tool including a tool head; a dispenser assembly including an actuatable reservoir and compound pot, wherein the actuatable reservoir is fluidically coupled with the compound pot to dispense a conditioning compound therein; a positioning assembly configured to move the conditioning device relative to the user device and the compound pot; and at least one non-transitory computer-readable medium including computer program code stored thereon that, when executed by at least one processor, configures the apparatus to: control the actuatable reservoir, the conditioning device, and the positioning assembly to execute at least one conditioning operation to operably engage the tool head with both the compound in the compound pot and with a plurality of locations on the at least one surface of the user device.

In some embodiments, the apparatus further includes a calibration tool configured to set a reference position for the positioning assembly, wherein the reference position is relative to one or more of the platform, the tool head, and the dispenser assembly.

In some embodiments, the conditioning device further includes a tool changer configured to operably engage the tool comprising the tool head

In some embodiments, the tool changer is a chuck.

In some embodiments, the positioning assembly includes at least one movable frame and at least one actuator, wherein the at least one actuator is configured to operably engage with the movable frame and move relative to the movable frame.

In some embodiments, the movable frame is a three-axis gantry configured to move the conditioning device above the user device.

In some embodiments, the conditioning device is configured to emit a signal when the at least one conditioning operation is complete.

In some embodiments, the conditioning compound is a non-aqueous polishing paste.

In some embodiments, the platform includes a vacuum table including one or more actuators configured to support and hold the user device in a fixed position on the platform.

In some embodiments, the platform includes one or more movable actuators configured to position and orient the user device into one or more positions and one or more orientations.

In some embodiments, the actuatable reservoir includes an actuator configured to dispense conditioning compound into the compound pot and the reservoir includes a syringe actuated by the actuator.

In some embodiments, the apparatus includes a movable cart configured to support one or more of the platform, the conditioning device, the dispenser assembly, and the positioning assembly.

In some embodiments, the plurality of locations includes at least one sensitive area and wherein the at least one conditioning operation is configured to refrain from operably engaging the tool head with the at least one sensitive area.

In some embodiments, the apparatus includes a polish head changing station, the polish head changing station including a cleaning tool configured to clean the user device following application of the compound to the user device.

In some embodiments, the polish head changing station further includes an actuatable tool mount configured to allow autonomous connection or disconnection with the tool head.

According to various embodiments, there is provided a system for conditioning at least one surface of a user device. In some embodiments, the system includes a handling device including an end effector, wherein the handling device is configured to operably engage the user device with the end effector and deliver the user device to an apparatus for conditioning the user device selected from a group of apparatuses for conditioning the user device. In some embodiments, the apparatus for conditioning the user device includes a platform configured to support the user device; a conditioning device configured to engage a tool including a tool head; a dispenser assembly including an actuatable reservoir and compound pot, wherein the actuatable reservoir is fluidically coupled with the compound pot to dispense a conditioning compound therein; a positioning assembly configured to move the conditioning device relative to the user device and the compound pot; and at least one non-transitory computer-readable medium including computer program code stored thereon that, when executed by at least one processor, configures the apparatus to: control the actuatable reservoir, the conditioning device, and the positioning assembly to execute at least one conditioning operation to operably engage the tool head with both the compound in the compound pot and with a plurality of locations on the at least one surface of the user device.

In some embodiments, the system further includes an imaging device configured to captured one or more images of the at least one conditioning operation, and wherein the imaging device is configured to transmit the one or more images of the at least one conditioning operation to the at least one non-transitory computer readable medium.

In some embodiments, the computer program code, when executed by the at least one processor, configures the apparatus to do one or more of: motion plan one or more of the actuatable reservoir, the conditioning device, and the positioning assembly during the at least one conditioning operation; perform location recognition for positioning or handling of the user device; and perform feature recognition for classifying or orienting the user device.

In some embodiments, the imaging device uses edge and/or blob find tools to analyze the one or more images.

In some embodiments, the positioning assembly includes at least one movable frame and at least one actuator, wherein the at least one actuator is configured to operably engage with the movable frame and move relative to the movable frame.

In some embodiments, the movable frame is a three-axis gantry configured to move the conditioning device above the user device.

In some embodiments, the conditioning device is configured to emit a signal when the at least one conditioning operation is complete.

In some embodiments, the conditioning compound is a non-aqueous polishing paste.

In some embodiments, the platform includes a vacuum table including one or more actuators configured to support and hold the user device in a fixed position on the platform.

In some embodiments, the platform includes one or more movable actuators configured to position and orient the user device into one or more positions and one or more orientations.

In some embodiments, the actuatable reservoir includes an actuator configured to dispense conditioning compound into the compound pot and the reservoir includes a syringe actuated by the actuator.

In some embodiments, the system includes a movable cart configured to support the apparatus for conditioning the user device.

In some embodiments, the plurality of locations includes at least one sensitive area and wherein the at least one conditioning operation is configured to refrain from operably engaging the tool head with the at least one sensitive area.

In some embodiments, the system includes a polish head changing station, the polish head changing station including a cleaning tool configured to clean the user device following application of the compound to the user device.

In some embodiments, the polish head changing station further includes an actuatable tool mount configured to allow autonomous connection or disconnection with the tool head.

According to various embodiments, there is provided a method for conditioning a user device. In some embodiments, the method includes operably engaging, with a handling device including an end effector, the user device with the end effector; delivering, with the handling device, the user device to an apparatus for conditioning the user device selected from a group of apparatuses for conditioning the user device, the apparatus for conditioning the user device including: a platform configured to support the user device; a conditioning device configured to engage a tool including a tool head; a dispenser assembly including an actuatable reservoir and compound pot, wherein the actuatable reservoir is fluidically coupled with the compound pot to dispense a conditioning compound therein; a positioning assembly configured to move the conditioning device relative to the user device and the compound pot; at least one non-transitory computer-readable medium including computer program code stored thereon that, may be executed by at least one processor; and controlling the actuatable reservoir, the conditioning device, and a polishing device, by the processor, to operably engage the tool head with the compound in the compound pot and with a plurality of locations on the at least one surface of the user device.

In some embodiments, the method includes removing, by the handling device, the user device from the platform with the end effector.

The above summary is provided merely for purposes of summarizing some example aspects to provide a basic understanding of some aspects of the disclosure. Accordingly, it will be appreciated that the above-described aspects are merely examples. It will be appreciated that the scope of the disclosure encompasses many potential aspects in addition to those here summarized, some of which will be further described below.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1A is a first angled view of an example conditioning system and conditioning apparatuses in accordance with various embodiments of the present disclosure;

FIG. 1B is a second angled view of an example conditioning system and conditioning apparatuses in accordance with various embodiments of the present disclosure;

FIG. 2 is an angled view of an example handling device in accordance with various embodiments of the present disclosure;

FIGS. 3A-B are angled views of an example conditioning apparatus in a first position and a second position, respectively, in accordance with various embodiments of the present disclosure;

FIG. 4A-D is an angled view of an example conditioning apparatus in accordance with various embodiments of the present disclosure;

FIG. 5 is a first angled view of an example platform configured to support a user device in accordance with various embodiments of the present disclosure;

FIG. 6 is a second angled view of an example platform configured to support a user device in accordance with various embodiments of the present disclosure;

FIG. 7A is a first front view of an example conditioning device in accordance with various embodiments of the present disclosure;

FIG. 7B is a second front view of an example conditioning device in accordance with various embodiments of the present disclosure;

FIG. 8 is an angled view of an example conditioning device engaged with an example user device in accordance with various embodiments of the present disclosure;

FIGS. 9A, 9B, and 9C are front views of an example conditioning device engaging an example tool head in accordance with various embodiments of the present disclosure;

FIGS. 10A and 10B are angled views of an example conditioning device engaging with an example calibration device in accordance with various embodiments of the present disclosure;

FIG. 11 is an angled view of an example actuatable reservoir in accordance with various embodiments of the present disclosure;

FIG. 12 is a flow chart illustrating an example method of conditioning a user device in accordance with various embodiments of the present disclosure;

FIG. 13 is a schematic of an example conditioning system in accordance with various embodiments of the present disclosure; and

FIG. 14 is a schematic of example components of an example master control system for an example conditioning system in accordance with various embodiments of the present disclosure.

### DETAILED DESCRIPTION OF SOME EXAMPLE ASPECTS

Various embodiments of the present disclosure now will be described more fully hereinafter with reference to the accompanying drawings, in which some, but not all embodiments of the disclosure are shown. Indeed, this disclosure may be embodied in many different forms and should not be construed as limited to the embodiments set forth herein; rather, these aspects are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one aspect of the present disclosure and may be included in more than one aspect of the present disclosure (importantly, such phrases do not necessarily may refer to the same aspect).

Embodiments of the present disclosure may be implemented as computer program products that comprise articles of manufacture. Such computer program products may include one or more software components including, for example, applications, software objects, methods, data structures, and/or the like. A software component may be coded in any of a variety of programming languages. An illustrative programming language may be a lower-level programming language such as an assembly language associated with a particular hardware architecture and/or operating system platform/system. A software component comprising assembly language instructions may require conversion into executable machine code by an assembler prior to execution by the hardware architecture and/or platform/system. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Additionally, or alternatively, embodiments of the present disclosure may be implemented as a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media may include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatuses, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### Overview

The disclosed embodiments may provide a low-cost and relatively low footprint solution for conditioning user devices that can be deployed in a standard reverse logistics environment without the need for costly support and controls. The disclosed embodiments may include automated mechanisms to condition user device glass surfaces by using a non-aqueous “paste” method to polish the glass surfaces to remove flaws (scratches, nicks, smudges, etc.). The disclosed embodiments may automate one or more of the processes of loading and unloading a user device, automatic dispensing of the paste, selecting one or more of multiple polish heads for use in a continuous production environment, removal of polishing remnants, and additional cleaning of the device (e.g., via a cleaning tool implementation of the polish heads) prior to removal from the unit. In some embodiments, an additional manual cleaning may be performed. The disclosed embodiments are usable in a single standalone “desktop” version as well as integrated with multiple units in a larger system for greater productivity. The system is designed to be flexible to support polishing and/or multiple functions/sub-functions used in the conditioning process in a single apparatus (e.g., polishing; functional test, which may include flashing/data wipe; RF test; etc.). In some embodiments, by using a non-aqueous polishing paste and compact polishing head and “mini-gantry” approach, the disclosed embodiments can be integrated into a compact system with multiple units to get process consistency, resulting in flaw removal from the front and back glass surfaces of user devices.

According to various embodiments, a conditioning system may include a plurality of apparatuses for conditioning a user device (e.g., a smart phone). The apparatuses may be combined into a single system in some embodiments. Conditioning may refer to several procedures, including polishing and repairing the screen (e.g., glass front and/or rear) of the user device. In some embodiments, the conditioning apparatuses within the system may be specialized. The system may include one or more devices (such as at least one conveyor and/or at least one actuator) that are configured to take a user device and deliver the user device to one of the conditioning apparatuses. In some embodiments, the system or a technician may first analyze the user device (e.g., the system may use a camera, scanner, or other imaging device and transmit the image to a master control system to be analyzed, or a computer system or technician may input one or more portions of the user device that need to be conditioned) before delivering the user device to the conditioning apparatus. In some embodiments, this analysis may comprise an indication of an extent of conditioning needed (e.g., light, medium, or heavy polishing). In some embodiments, this analysis may inform the system as to which conditioning apparatus the user device should be delivered (e.g., to an apparatus programmed to polish the screen, or an apparatus programmed to perform a functional test).

According to various embodiments, the conditioning apparatus may have several assemblies and components configured to carry out the conditioning procedures. In some embodiments, the apparatus may have a platform configured to support the user device during the conditioning procedure. In some embodiments, the apparatus may have a conditioning device configured to engage with and hold a tool head, which the conditioning device then uses to perform the conditioning procedures on the user device. The apparatus may have a dispenser assembly including an actuatable reservoir and a compound pot containing a compound solution configured to be dispensed by the conditioning device onto the user device. The apparatus may have a positioning assembly configured to move the conditioning device relative to the user device and to various components of the apparatus. The positioning assembly may be configured to move (either automatically by a program or by a technician) the conditioning device over the user device to condition said user device; for example, the positioning device may move the conditioning device across the surface of the user device and thereby polish it. In some embodiments, the positioning assembly may move the conditioning device to the dispenser assembly, which may dispense a conditioning compound onto the conditioning device for use in conditioning the user device (or the conditioning device may operably engage with the dispensing assembly such that the conditioning compound is disposed on the conditioning device). This conditioning compound may be a non-aqueous compound used to repair and polish the screen of the user device.

According to various embodiments, the system may include a processor configured to execute computer program code stored on at least one non-transitory computer-readable medium. The system may also include one or more imaging device(s) configured to capture one or more images of the apparatus and various components and assemblies of the apparatus. The executed computer program code may cause the system to begin one or more conditioning operations on the user device (e.g., polishing or otherwise repairing a screen of a user device). In some embodiments, the program code may cause a master control system of the conditioning system to analyze these one or more images so that the system: motion plans the conditioning device and the positioning assembly during a conditioning operation, recognizes the location of the user device on the apparatus, and/or recognizes features of the user device in need of conditioning (e.g., the front and/or rear of the device, the screen of the device, and/or scratches on the screen). In some embodiments, the various embodiments of processor(s) and computer-readable medium (a) may each be operably connected to the system. In some embodiments, one or more individual apparatuses described herein may include its own computing hardware (e.g., processors, memories, communications interface, etc.). In some embodiments, two or more apparatuses may be controlled by and/or share the same computing hardware, whether such hardware is physically located in such apparatuses or connected from another location. For example, each system may include its own computing hardware handling operations on multiple conditioning apparatuses. In some embodiments, each conditioning apparatus may additionally or alternatively have computing hardware individually associated therewith. In some embodiments at least a portion of the computing hardware may be separate from the system. In some embodiments, the computer program code may control various assemblies and components of the system when executed by one or more processors. For example, the code may contain instructions for running a conditioning operation on a user device that, when the code is executed by the processor, cause the actuatable reservoir, the conditioning device, and/or the positioning device to execute at least one conditioning operation. During the conditioning operation, the tool head of the conditioning device may operably engage with the compound in the compound pot of the dispenser assembly and a plurality of locations on the surface of the user device. The plurality of locations may include areas of the user device in need of conditioning, such as areas that need polishing and/or other repairing.

The various assemblies, components, and devices of the conditioning system and apparatuses will now be described.

### Example Conditioning Apparatuses and Systems

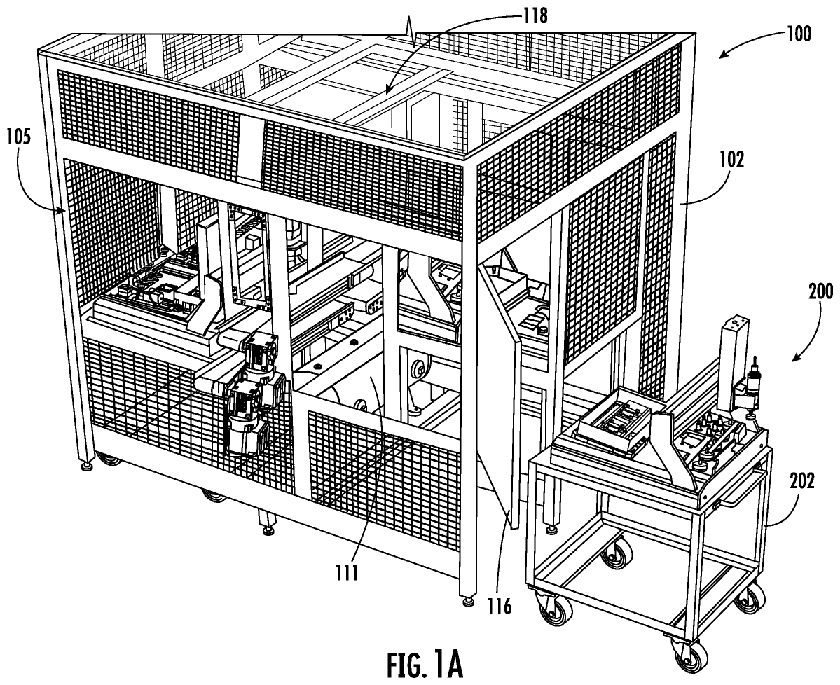

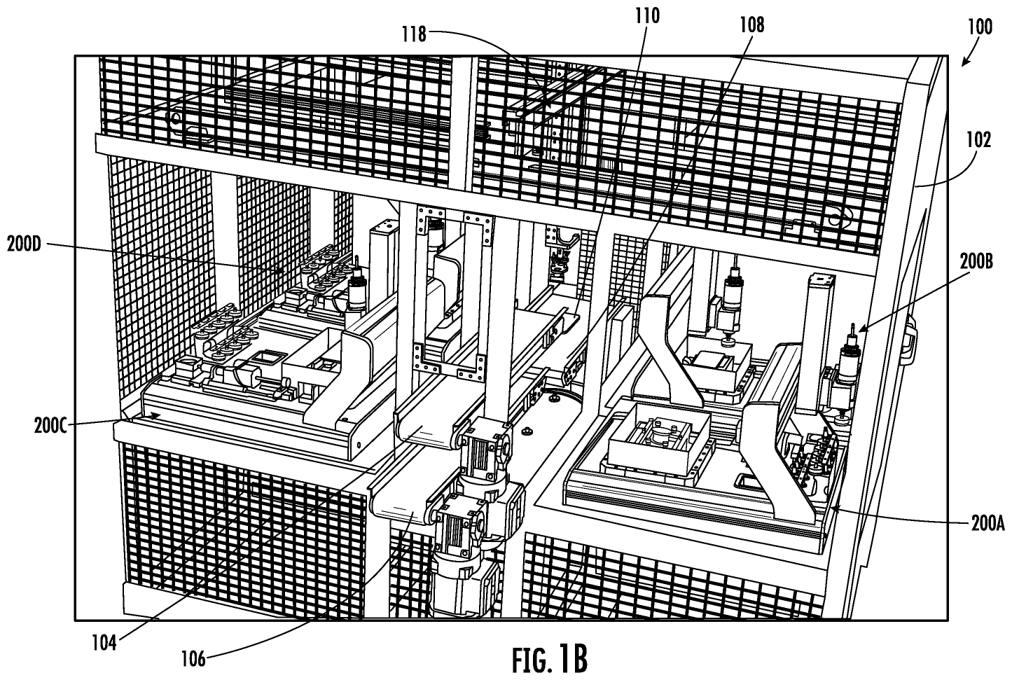

Referring now to FIG. 1A, a conditioning system 100 for conditioning a user device 110 according to some embodiments of the present disclosure is provided. In some embodiments, the system 100 may include one or more conditioning apparatuses 200. Four apparatuses 200 are shown in FIG. 1A. However, a system 100 may include more than four or fewer than four apparatuses 200, and/or the apparatuses 200 may be operated individually as standalone units, depending on the requirements of the system 100. In some embodiments, the system 100 may include a housing 102 configured to contain the one or more apparatuses 200. In some embodiments, the housing 102 may be a metallic, substantially box-shaped cage. In some embodiments, the housing 102 may include one or more access doors 116 for adding and removing the apparatuses from the housing. The one or more sensors may be associated with the access doors 116 (e.g., latch sensors) to detect when the doors are open and closed. The conditioning process may be configured to check for door 116 closure before attempting to operate the system and/or individual apparatuses (e.g., an automatic failsafe). In some embodiments, the slots into which the apparatuses 200 are inserted in the system 100 may be configured to position the apparatuses 200 in a known, predetermined location for interacting with one or more other components of the system. In some embodiments, the housing 102 may include one or more windows 105 configured to allow technicians or other observers to see inside the system 100 and/or the apparatus 200 during operation. In some embodiments, the windows 105 may be glass windows, plastic windows, or voids. Various components of the apparatus 200 will be described in greater detail later in this disclosure. As shown in FIG. 1A, in some embodiments, the apparatus 200 may include a movable cart 202 configured to move the apparatus 200 into and out of the housing 102 of the system 100. In some embodiments, the apparatus 200 may be fixedly attached to the cart 202. In other embodiments, the apparatus 200 may be placed on the cart 202 by a technician. In some embodiments, the apparatus 200 may be configured to be fixed to a stationary table or bench top.

Referring now to FIG. 1B, in some embodiments, multiple conditioning apparatuses 200A, 200B, 200C, and 200D according to one or more embodiments of the present disclosure may be positioned within the housing 102 of the system 100 (e.g., by rolling in the apparatuses on the movable carts 202). The system 100 may include various components configured to deliver user devices to the apparatuses. In some embodiments, the system 100 may include one or more conveyors, including an output conveyor 104, a first lower conveyor 106, and a second lower conveyor 108. In some embodiments, one or more of the conveyors may be configured to receive a user device 110 from outside the system 100, such as by a technician placing the user device 110 on one of the conveyors. In some embodiments, access points to the one or more conveyors 104, 106, 108 may be on the sides of the housing 102 or on the top of the housing 102. In some embodiments, an automated system may collect the user device 110 and bring it into the system 100. In some embodiments, the one or more conveyors 104, 106, 108 may be configured to move a user device 110 between them. For example, a user device 110 may be placed on the first lower conveyor 106 (e.g., by an operator or by an automated system such as a robotic arm), the first lower conveyor 106 may transport the user device 110 to the second lower conveyor 108 In some embodiments, the output conveyor 104 may be configured to support the user device 110 after completion of an operation (e.g., cleaning). In some embodiments, the output conveyor 104 may be configured to convey the user device 110 outside of the housing 102 of the system 100. One phase of these example movements is shown in FIG. 1B, with the user device 110 positioned on the second lower conveyor 108. In some embodiments, multiple user devices may be placed on the conveyors simultaneously, allowing the system to process multiple user devices simultaneously.

Referring still to FIG. 1B, in some embodiments, the system 100 may include an air tank 111, which may be located within the housing 102. In some embodiments, the air tank 111 may be disposed below the conveyors 104, 106, 108. In some embodiments, the air tank 111 may act as a buffer (e.g., reserve) supply for the system 100 in the event that system 100 is cut off from an external supply of air.

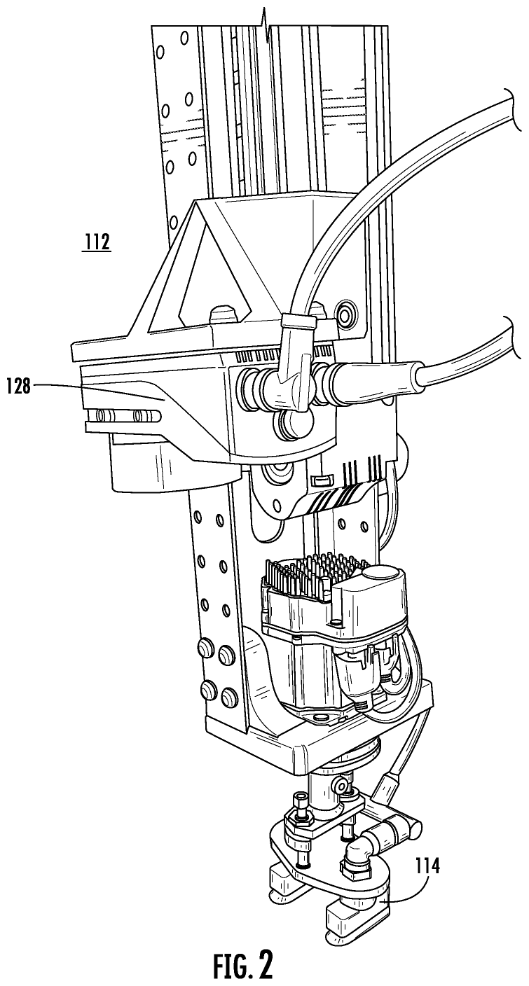

With reference to FIG. 2, in some embodiments, an imaging device 128 (e.g., as part of a central handling system or otherwise arranged in communication with the system and/or one or more individual apparatuses) may be used to control at least a portion of the conditioning processes. In some embodiments, the imaging device 128 and associated circuitry may be configured to capture and process one or more images of a user device 110 prior to transferring the user device to a conditioning apparatus 200. In some such embodiments, one or more conveyors (e.g., second lower conveyor 108) may be transparent and may be backlit (e.g., via a light disposed within the conveyor below its top surface) to facilitate imaging of a silhouette of the user device for identification and/or orientation analysis. In some embodiments, one or more conveyors may be forelit to facilitate detailed, clear imagery of the upward-facing surface of the user device. In the embodiment depicted in FIG. 2, the imaging device 128 is attached to the handling device 112 and movable with the end effector 114 to provide overhead, top-down imaging of the system 100 and various apparatuses 200 and portions thereof for use with the various processes and systems described herein. One or more additional or alternative cameras may be mounted in a stationary position within the system not attached to the handling device.

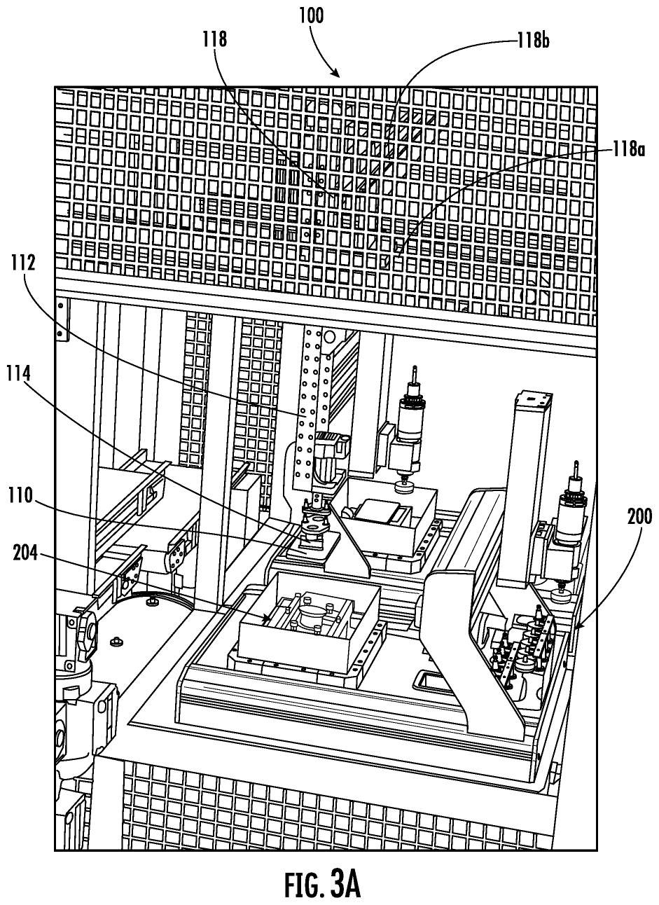

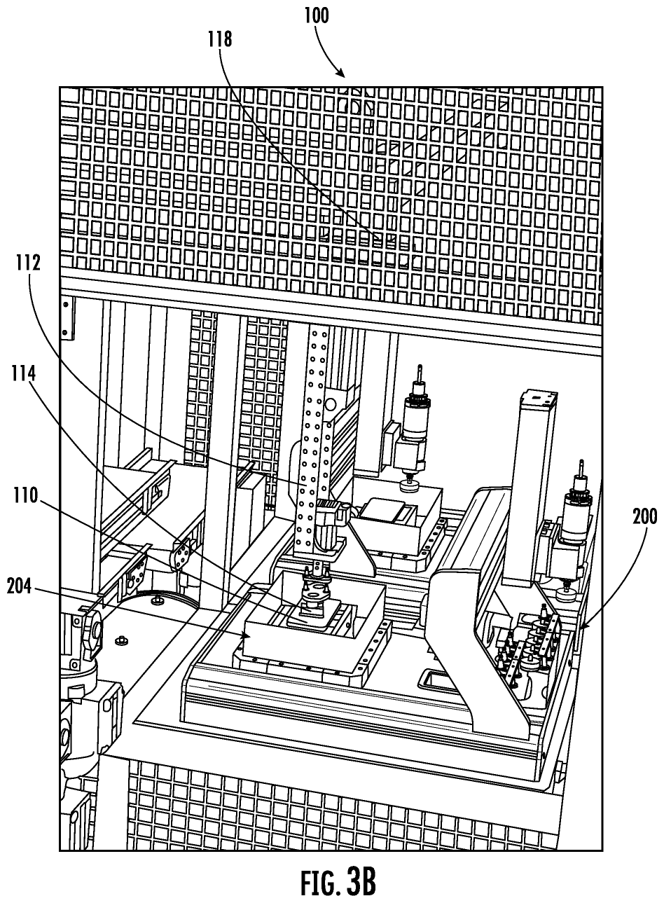

Referring now to FIGS. 3A and 3B, in some embodiments, the system 100 may include a handling device 112. In some embodiments, the handling device 112 may include an end effector 114. As shown in at least FIGS. 3A and 3B, the handling device 112 may be connected to a positioning device 118 (such as a multi-axis gantry) disposed at the top of the housing 102 and configured to move the handling device 112 around the system 100 and inside the housing 102. In some embodiments, the positioning device 118 may be controlled by an automated system and/or remote manual control to move the handling device 112 within the system 100. In some embodiments, the handling device 112 may be an actuator configured to manipulate the end effector 114, which may be a tool configured to operably engage the user device 110 (e.g., a vacuum tool, a grasping tool, or the like). In some embodiments, the handling device 112 may be configured to operably engage the user device 110 with the end effector 114 (e.g., via suction, jaws, adhesive, or the like) and to deliver the user device to one of the conditioning apparatuses 200. For example, the positioning device 118 may control at least two or three axes of motion of the handling device 112 to position the handling device 112 above a user device for engagement. In some embodiments, an upper frame of the positioning device 118 and accompanying drive system may control x-y movement in a horizontal plane while an actuator (e.g., a motor) controls a z axis of movement. Such a drive system may include two axial drives (e.g., motors and guide rails as depicted in FIGS. 1A-1B) within a horizontal plane to position the end effector 114 over a target device. The z-axis actuator may then translate the end effector vertically into contact with the user device. For example, as shown in FIG. 3A, the handling device 112 has delivered the user device 110 to conditioning apparatus 200A, and, as shown in FIG. 3B, the handling device 112 has placed the user device 110 on a platform 204 of the apparatus 200A. Moreover, the embodiment of FIG. 3B illustrates a first rail assembly 118a and a second rail assembly 118b of the positioning device 118 configured to move the handling device 112 in the x-y plane.

As described herein, a camera or other imaging device may be positioned with a field of view that includes the user device(s) and possible user device destinations such that the camera may facilitate motion planning by the computing system (e.g., via analysis of a condition of the user device, analysis of an identity of the user device, analysis of an orientation and/or of the user device, and/or position detection with respect to other elements of the system). In some embodiments, the system 100 may include a camera, scanner, or other imaging device configured to scan a code or a label disposed on the user device and determine the model of the user device. For example, an imaging device may capture images that enable the computing system to detect that the user device is a smart phone and additionally the make and model of the smart phone. This information may then be input into the system 100 and, through processes described in greater detail later in the specification, the inputted data may aid the system 100 and/or a technician in deciding on an optimal conditioning operation for the user device 110. In some embodiments, the imaging device may be a separate component of the system 100, or it may be disposed on or integrated into the handling device 112. In some embodiments, depending on the type of user device detected by the imaging device or other imaging analysis, the user device may be placed into a particular one of the conditioning apparatuses 200A-D of the system 100 via a conditioning and motion planning algorithm. In some embodiments, the imaging device may facilitate feedback control of the positioning device 118 and/or handling device 112.

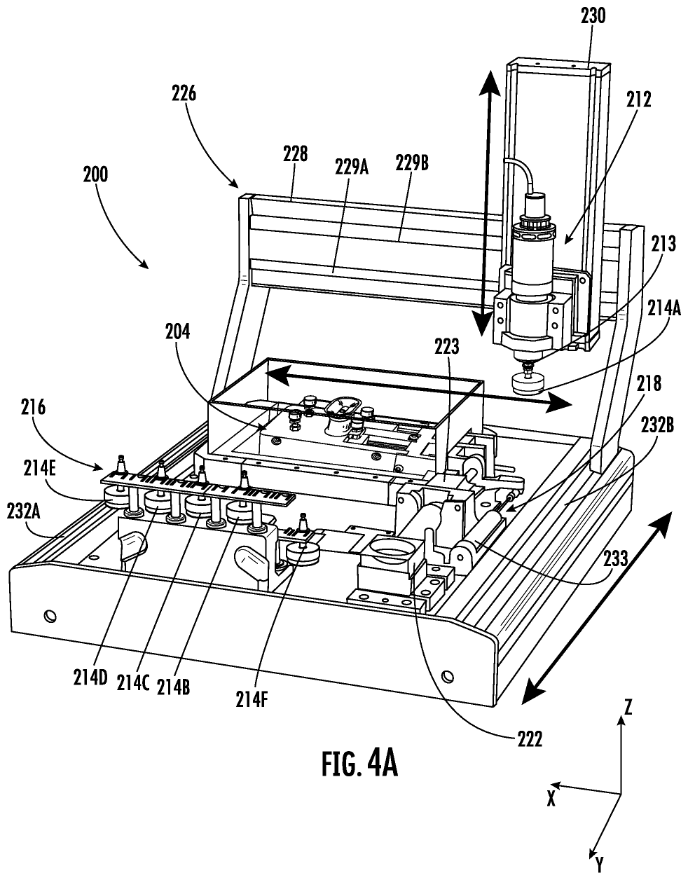

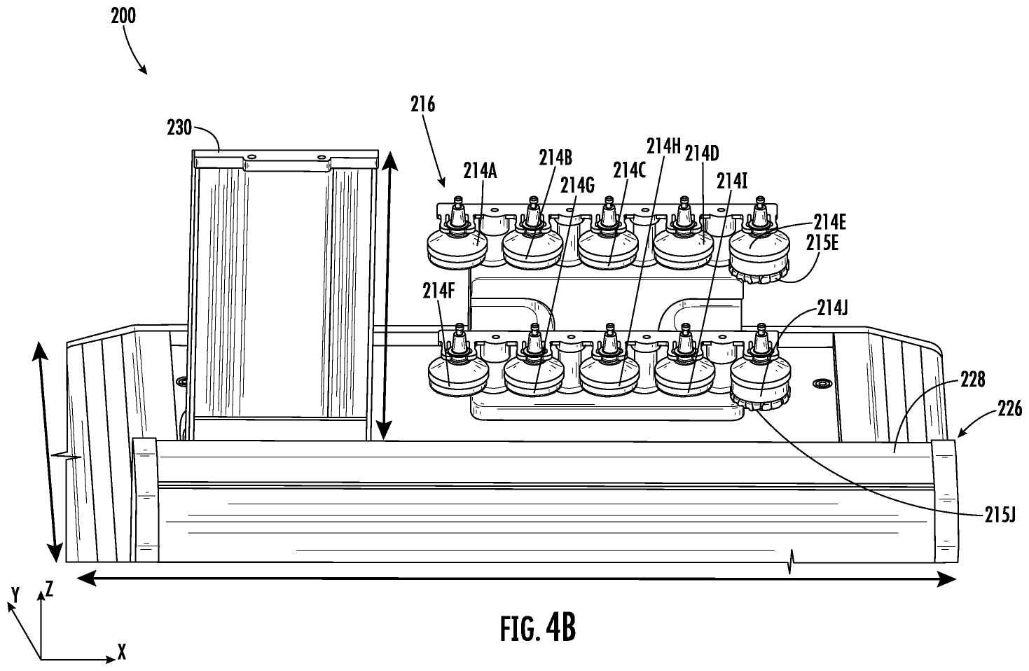

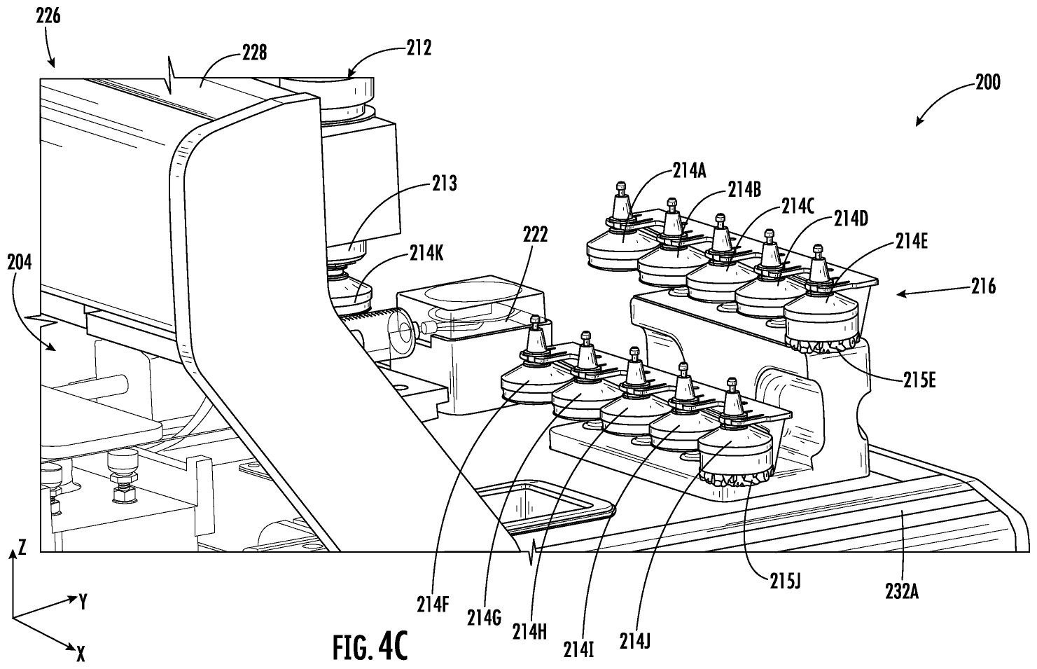

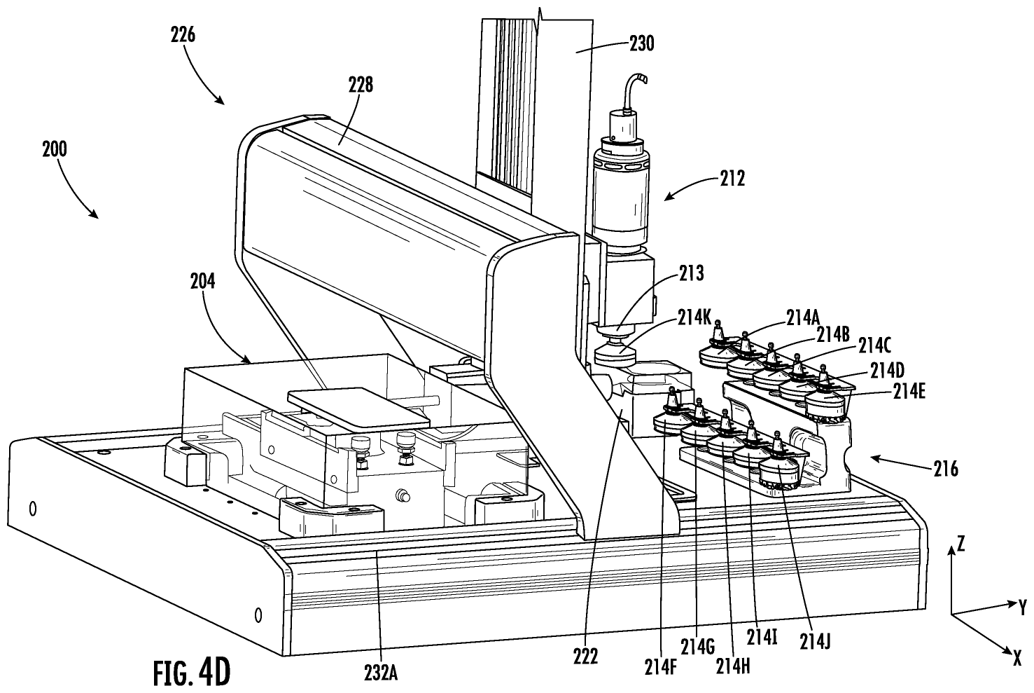

Referring now to FIGS. 4-11, various views of an example conditioning apparatus 200 are shown. The conditioning apparatus 200 may have a conditioning device 212 and a variety of assemblies, including a dispenser assembly 218 and a positioning assembly 226. The various assemblies and components of an example apparatus 200 will now be described in detail.

Referring now to FIGS. 4, 5, and 6, in some embodiments, the apparatus 200 includes the platform 204, which may be configured to support a user device 110. In some embodiments, the platform 204 may be a rigid, rectangular block configured to receive the user device 110. In some embodiments, the platform 204 may be fixedly attached to an upper side of the apparatus 200. In other embodiments, the platform may be movable on the apparatus 200 (e.g., by removable fasteners, by sliding tracks disposed on the apparatus 200 and configured to move the platform 204 around the apparatus 200, or the like). In some embodiments, the platform 204 may have other shapes (e.g., circular), which may be configured for supporting the user device 110. In some embodiments, the platform 204 may be a vacuum table, and may comprise one or more vacuum openings configured to apply suction to the user device. In some embodiments, the platform 204 may be surrounded by an exterior wall made of a transparent or semi-transparent material, such as glass or plastic. In some embodiments, one or more lights or other illumination devices may be disposed on or around the platform 204 to illuminate the user device, to aid in visualization during the conditioning process.

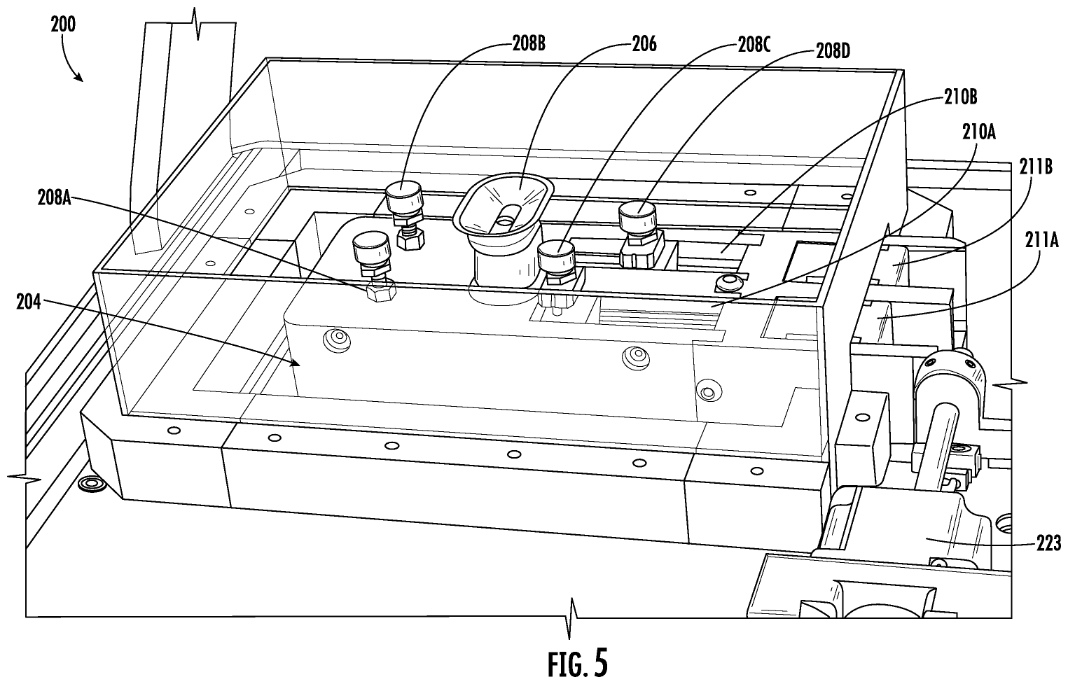

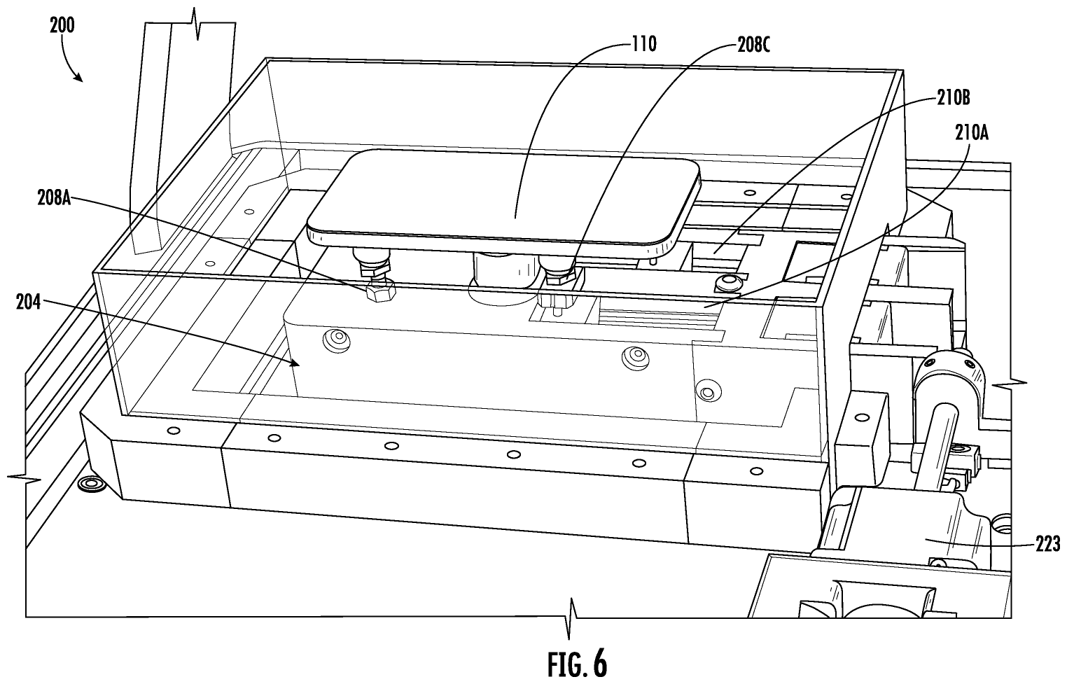

In some embodiments, the platform 204 may include a receiving component 206 and one or more supports 208A, 208B, 208C, 208D, as shown in at least FIG. 5. In some embodiments, one or more of the supports (e.g., supports 208C and 208D in FIG. 5) may be actuatable and may be configured to move within one or more tracks 210A, 210B. For example, a pair of linear actuators 211A, 211B may be configured to translate the actuatable supports 208C, 208D along the channel. In some embodiments, one or more of the supports 208A-208D may be manually adjustable and/or removable (e.g., threaded into openings in the platform 204 and/or slidable by hand). In some embodiments, one or more of the supports (e.g., supports 208A and 208B shown in FIG. 5) may be stationary and fixed relative to the rest of the platform 204. In some embodiments, the supports 208A-D may be placed in a substantially rectangular formation, but in other embodiments they may be oriented toward a variety of polygonal shapes. In at least this way, the supports 208A-D may be adjusted to accommodate different sizes and shapes of user device 110. These adjustments may be configured to fit the supports 208A-D within the outer profile of the user device 110 such that each support 208A-D engages a surface of the user device (e.g., five total points of contact in the illustrated embodiment). In some embodiments, the supports (e.g., actuatable supports 208C-D) may be moved and/or removed to avoid contacting uneven surfaces (e.g., camera lenses) on the user device. In the depicted embodiments, the supports 208A-D include circular support surfaces. In some embodiments, the platform 204 may be configured to support a user device 110, as shown in FIG. 6, by means of the receiving component and/or the actuatable supports. In some embodiments, the receiving component may be a suction component that may secure and hold the user device in a stable position, while the supports may stabilize the user device. For example, the receiving component 206 in the illustrated embodiment includes a flexible skirt (e.g., made of an elastomeric material) surrounding a center vacuum opening configured to connect to a pump. The skirt seals against a surface of the user device while the pump removes the air within the receiving component 206. FIG. 5 shows the platform 204 without the user device disposed on it, while FIG. 6 shows the platform 204 supporting the user device 110, being supported by the actuatable supports 208A-D and secured by the receiving component 206.

Referring now to FIGS. 4A-4D, 7A, 7B, 8, 9A, 9B, 9C, 10A, and 10B, in some embodiments, the apparatus 200 includes a conditioning device 212. In some embodiments, the device 212 may include a motor that drives a tool changer 213, the tool changer 213 being configured to engage and disengage one or more tools 214A-K, etc. In some embodiments, the tool changer 213 may be a chuck or similar device configured to operably engage and disengage with one or more tools 214A-K. In some embodiments, an example tool 214A may have one or more tool heads (e.g., 215E, 215J) disposed on the end of the tools. In some embodiments, an example tool head 215E may be a polishing pad. In some embodiments, one or more of the tool heads (e.g., 215E, 215J) may be custom tool heads. In some embodiments, the conditioning device 212 may be configured to execute a conditioning operation using one or more of the tool heads. The tools 214A-F and the respective tool heads may be configured for one or more conditioning operations that may be executed on the user device 110. In some embodiments, the conditioning device 212 may be configured to spin the tool 214A when engaged with the user device 110 and apply varying degrees of pressure to the user device 110 through the tool 214A (e.g., controlling both rotational speed and downward force from the conditioning device actuator pushing the tool head into the user device). In some embodiments, the conditioning device 212 may be configured to actuate at various depths on the user device 110 via a positioning component 230 configured to raise and lower the conditioning device 212. In some embodiments, the positioning component may be part of the conditioning device or part of a supporting gantry assembly holding the conditioning device. In some embodiments, the apparatus 200 may include a signaling component configured to emit a signal once a conditioning operation has been completed. In some embodiments, a computing device associated with the apparatus 200 may include the signaling component. In some embodiments, the signal may be an audio and/or visual signal to a technician, or a wireless signal sent to an associated computing device, as will be described later in this disclosure. In some embodiments, the conditioning device 212 may return signals indicative of device performance (e.g., RPM, uptime, current draw, axial force on the tool, torque, etc.) to the computing device for monitoring as part of the conditioning process (e.g., as one or more feedback inputs for a controller). The associated computing device may be configured to control operation of the conditioning device 212 to deliver the polishing compound and condition the surface.

In some embodiments, the apparatus 200 may include a tool changing station 216 configured to store one or more of the tools (e.g., 214B, C, D, E, and F). In some embodiments, at least two of the tools 214A-F, and as many as all of the tools, may be identical to facilitate rapid swapping of used tools for new ones. In some embodiments, at least two of the tools 214A-F, and as many as all of the tools, may be different in one or more properties (e.g., tool head thickness, abrasiveness, etc.). In some embodiments, the tool changer 213 of the conditioning device may be remotely actuatable to allow autonomous connection or disconnection with one or more of the tools 214A-F.

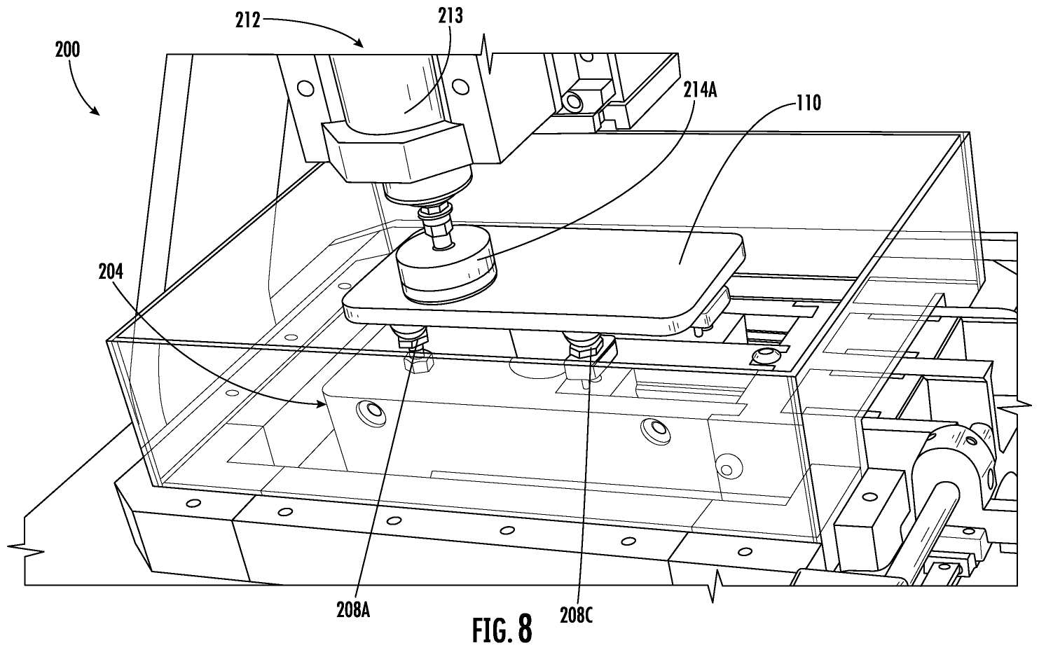

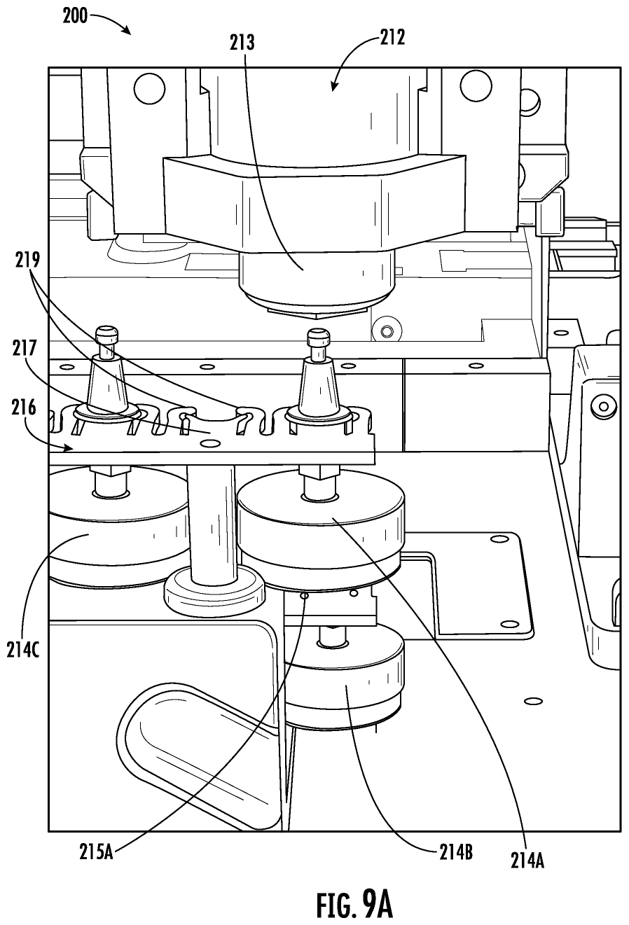

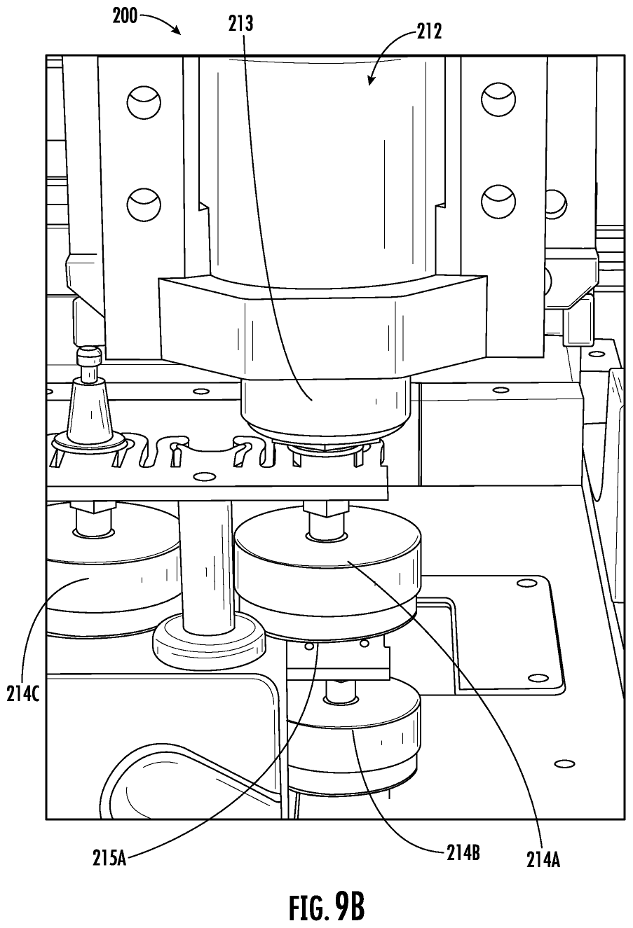

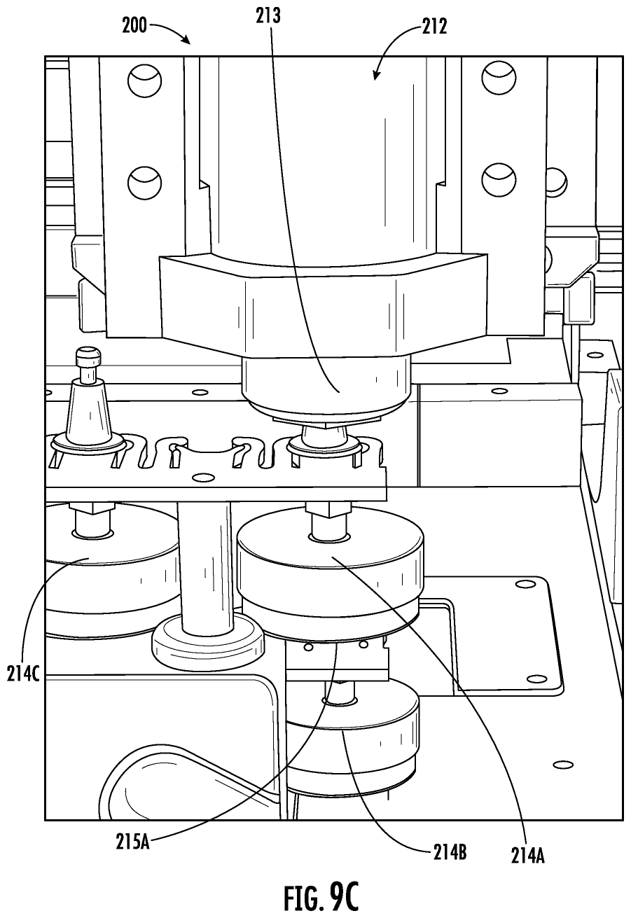

In some embodiments, the conditioning device 212 may be configured to engage with the changing station 216 to swap out one tool (e.g., 214A) for another (e.g., 214B), depending on the conditioning needs of the user device 110, or the conditioning operation (or portion thereof) that is being run. According to various embodiments, the conditioning device 212 is shown in FIGS. 9A, 9B, and 9C operably engaging with a tool 214A that is on a tool changing station 216. In FIG. 9A, the tool changer 213 of the conditioning device 212 is positioned above a tool 214A. In FIG. 9B, the tool changer 213 is shown operably engaging with the tool head 214A. In the depicted embodiment, the tools 214A-F include a tapered shaft with a notch and head for engaging the tool changer. The tool changer 213 may include an internal clamping mechanism configured to center on the tapered shaft and secure the tool at the notch. In FIG. 9C, the conditioning device 212 is shown extracting the tool 214A from the changing station 216. In some embodiments, this extraction may be aided by the actuatable tool mount of the tool changing station 216.

In the depicted embodiment, the tool changing station 216 includes a plurality of holders comprising a center strut 217 and two side prongs 219. The holders of the tool changing station 216 may hold each tool 214A-F beneath a flange of the tools, which flange is disposed below the tapered shaft of the tools. In the depicted embodiment, the holders are staggered vertically and horizontally, and there is a clear vertical space above the shaft of each tool for the conditioning device 212 to be lowered atop the chosen tool for engagement. In some embodiments, the tool changing station 216 itself may be removable and replaceable, such that the tool supply of a conditioning apparatus 200 may be quickly refreshed or the purpose of the apparatus quickly retooled by swapping tool changing stations. In some embodiments, the conditioning apparatus may detect or may otherwise receive instructions associated with the received tool changing station indicating which tools are loaded into the holders.

Referring now to FIGS. 4A-D, 7A, 7B, and 11, in some embodiments, the apparatus 200 may include a dispenser assembly 218. In some embodiments, the dispenser assembly 218 may include an actuatable reservoir 220 and a compound pot 222. In some embodiments, a conditioning compound may be disposed within the compound pot 222. In some embodiments, the actuatable reservoir 220 may be fluidically coupled to the compound pot 222 and configured to dispense the conditioning compound into the compound pot 222. In some embodiments, the compound pot 222 may be a channeled stamping pot configured to ensure one or more of a consistent amount or a consistent distribution of the conditioning compound onto the surface of the user device 110. For example, the compound pot 222 may comprise a channel opening 221 at or along the bottom surface of the pot configured to receive polishing compound therethrough. In some embodiments, the conditioning compound may be a non-aqueous polishing paste. For example, the paste may be a diamond compound (e.g., polycrystalline diamond, monocrystalline diamond, etc.) that is water soluble and compatible with glycol, water, or alcohol based lubricants.

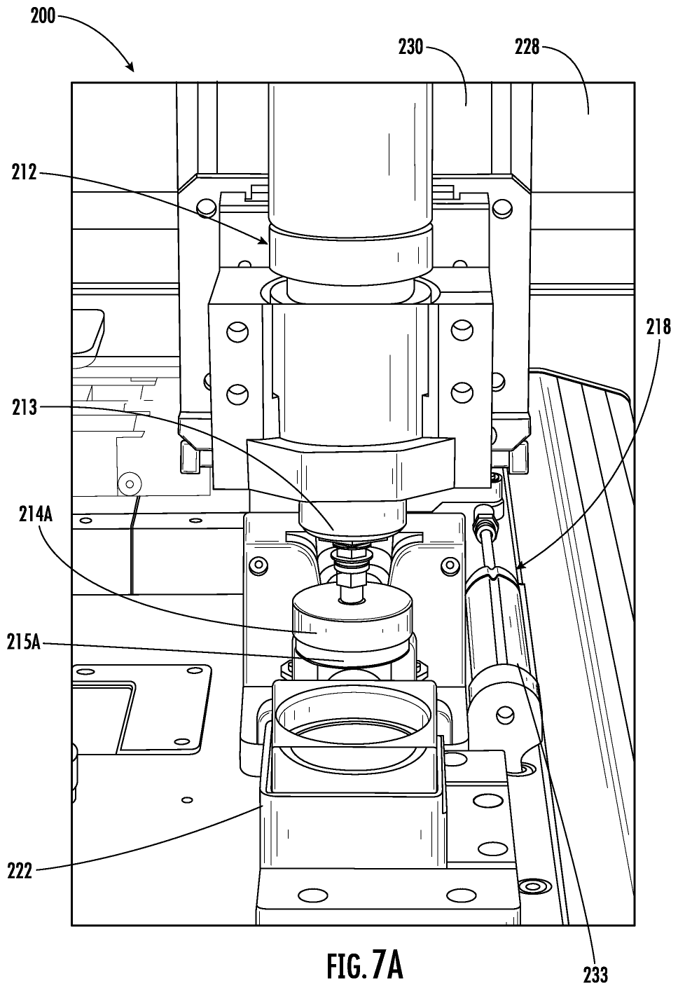

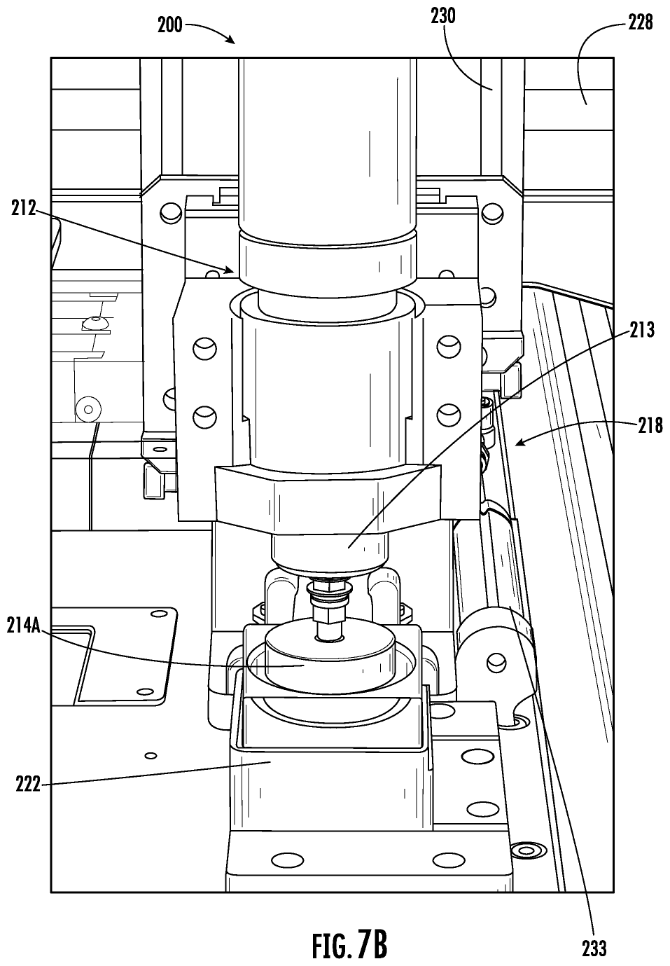

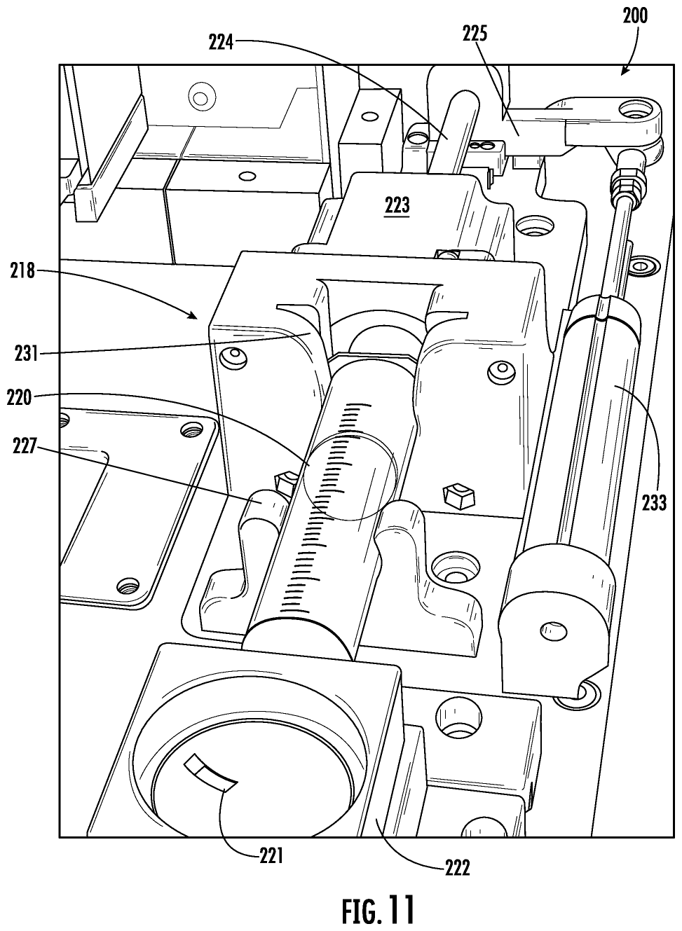

In some embodiments, and as shown in greater detail in FIG. 11, the dispenser assembly 218 may include an actuatable reservoir 220 connected to an actuator 223, such as a Nema motor with a lead screw. In some embodiments, the depicted actuatable reservoir may be a syringe body engaged with the compound pot 222 (e.g., via an orifice in the compound pot 222), which may include a threaded Luer lock to secure the actuatable reservoir 220 to the pot 222. In some embodiments, the actuator 223 may be configured to actuate the actuatable reservoir 220 to dispense the conditioning compound into the compound pot 222. In the depicted embodiment of FIG. 11, a potentiometer 233 is connected to the actuator 223 via a connector 225, and the potentiometer 233 may be configured to measure paste use and provide a signal back to one or more associated computing devices indicative of the paste use. In some embodiments, the plunger may lock into or otherwise engage the lead screw of the actuator 223 to facilitate bidirectional operation of the plunger. For example, a lead screw adapter of the actuator 223 may be keyed. The actuatable reservoir 220 may be held at least in part by a clamp 227 that allows the actuatable reservoir 220 to be held in place during dispensing while still being removable without tools. The dispenser assembly 218 may further include a tapered slot 231 into which a proximal end of the actuatable reservoir 220 is inserted to align with the shaft 224 and pusher disposed at the end thereof. In some embodiments, conditioning compound may be configured to be applied to the one or more tool heads (e.g., 215E, 215J) via the conditioning device 212 lowering the tool head into the compound pot as shown in the sequence of FIGS. 7A-7B.

According to various embodiments, and as shown in FIGS. 7A and 7B, the dispenser assembly 218 may be configured to receive a tool head 215A of a tool 214A that is operably engaged with the conditioning device 212. As shown in FIG. 7A, the tool head 215A may be positioned above the compound pot 222 containing the compound. In the position shown in FIG. 7A, the compound will have already been deposited into the compound pot 222. In some embodiments, the tool head 215A may be moved over the compound pot 222 by a positioning assembly 226, as described herein. As shown in FIG. 7B, the tool head 215A may be lowered into the compound pot to receive the conditioning compound. In some embodiments, the conditioning compound may be a non-aqueous polishing paste that is then used by the tool head 215A to polish and/or repair a user device 110. In some embodiments, the tool head 215A may also be configured to remove excess compound from the user device once the conditioning procedure has been completed. In some embodiments, the conditioning device 212 may be configured to use one tool head (e.g., 215A) to apply the compound, then the conditioning device may swap out for a second tool (e.g., cleaning tools 214E, J) and tool heads (e.g., 215E and 215J) to remove the excess conditioning compound from the user device (e.g., a cleaning head).

Referring now to FIG. 4, in some embodiments, the apparatus 200 includes a positioning assembly 226 configured to move the conditioning device 212 on at least two or three degrees of freedom (e.g., three translational degrees of freedom). In some embodiments, the positioning assembly 226 may include a movable frame positioned above the platform 204 of the apparatus 200 and configured to move the conditioning device 212 relative to the user device 110 and/or various components of the apparatus 200, such as the compound pot 222. For example, the positioning assembly 226 may move the conditioning device 212 to a first position above the user device 110 positioned on the platform 204. In some embodiments, the positioning assembly 226 may be configured to move the conditioning device 212 to a plurality of other locations over the user device 110 to perform various conditioning procedures on the user device 110 (e.g., translating in at least the x-y plane shown in FIG. 4 to run the tool head across multiple locations on the user device surface). For example, the positioning assembly 226 may move the conditioning device 212 to a plurality of locations on the user device that need repair and/or polishing (e.g., where the screen of the device has been scratched). In some embodiments, the positioning assembly 226 may be configured to move the conditioning device 212 to avoid various locations on the user device, such as sensitive areas where the conditioning compound should not be deposited (e.g., speaker mesh).

In some embodiments, the positioning assembly 226 may be a gantry with a first positioning component 228 and a second positioning component 230 configured to control movement along at least two degrees of freedom. In some embodiments, the axes the positioning assembly 226 moves the conditioning device 212 along may be indicated by the arrows in FIG. 4. In some embodiments, the illustrated axes may be perpendicular along the respective X, Y, and Z directions indicated in the legend of FIG. 4. In some embodiments, the first positioning component 228 may be configured to move along one or more tracks 232A, 232B inlaid on the apparatus 200 (e.g., driven by one or more motors, such as stepper motors, or other drive components, such as linear actuators) to cause the conditioning device 212 to move in the positive and negative Y direction relative to the depicted embodiment. In some embodiments, the second positioning component 230 may be configured to at least move along the first positioning component 228 (e.g., driven by one or more motors, such as stepper motors, or other drive components, such as linear actuators), such as long one or more tracks 229A, 229B disposed on the first positioning component 228 (e.g., along the positive and negative X direction relative to the depicted embodiment). In some embodiments, the positioning assembly 226 may be configured to move the conditioning device 212 upwards and downwards (e.g., along the positive and negative Z direction relative to the depicted embodiment) via the second positioning component 230. For example, the second positioning component 230, or a portion thereof, may be configured to move (e.g., along the Z axis relative to the first positioning component 228 to move the tool 214A-F upwards and downwards. Thus, in the depicted embodiment, the positioning assembly 226 is configured to move the conditioning device 212 along at least three translational degrees of freedom.

In some embodiments, the positioning assembly 226 may be configured to be moved by one or more motors, such as a stepper motor, that may be operably connected to the apparatus 200. For example, the motor(s) may be controlled via a computing device (e.g., a controller) configured to direct the final position of the tool head of the conditioning device via inputs into the various motors (or other drive components, such as linear actuators) to cause the conditioning device to be moved along two or three axes. In some embodiments, the stepper motor may be disposed within the apparatus 200 and may be controlled automatically by an autonomous system (such as the computing devices and systems described herein). In some embodiments, the positioning assembly 226 may comprise a robotic arm. In other embodiments, one or more of the first or second axis positioning components 228, 230 may be robotic arms. The positioning device 118 described above with respect to the system, which may be configured to handle user devices across multiple apparatuses, may operate in a substantially similar manner (e.g., via control of one or more motors or other drive components).

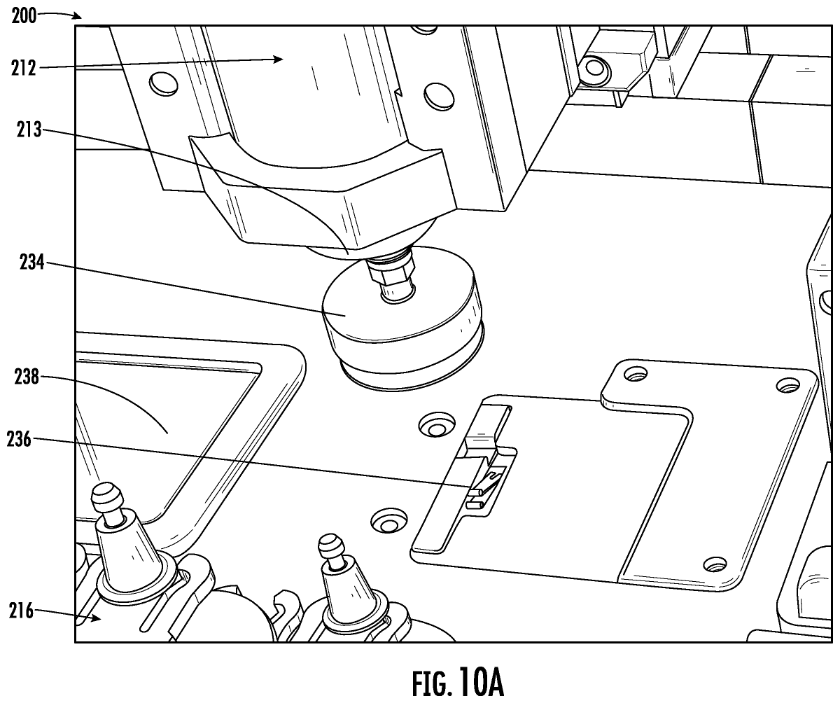

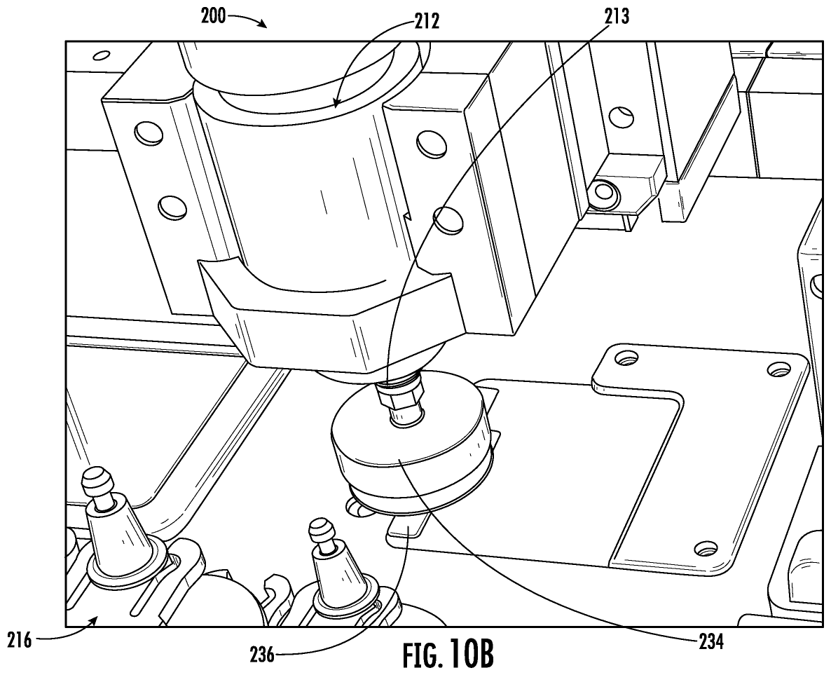

Referring now to FIGS. 10A and 10B, in some embodiments, the apparatus 200 may include a calibration tool 234 and a calibration station 236. In some embodiments, the calibration tool 234 may be configured to be used by the apparatus 200 to set a reference position for the positioning assembly 226 to be used for control of the conditioning device 212 to direct the positioning of the tool head. In some embodiments, the calibration station 236 may comprise an electrical contact (e.g., a spring contact in the illustrated embodiment) configured to be operably engaged with the calibration tool 234 and, when engaged (e.g., pressed down by the calibration tool 234), the apparatus 200 may then register this point as a reference position. In some embodiments, the computing device controlling the apparatus may register a calibration position when the electrical contact closes (e.g., the two ends of the spring contact come together) and a signal is transmitted back to the computing device. The reference position may, for example, have Cartesian coordinates of (0,0,0), and the remaining locations on the apparatus may be defined in reference to this reference position. In some embodiments, the calibration tool 234 may be stored at the tool changing station 216. In some embodiments, the calibration tool 234 may be discarded (e.g., in a disposal chute 238 such as is illustrated in the example embodiment of FIGS. 10A-10B). In some embodiments, a technician may calibrate the apparatus 200 using the calibration station 236 prior to the use of the apparatus 200. In other embodiments, calibration may be performed automatically by the system 100 on the apparatus 200, or by the apparatus 200 itself (e.g., periodically, such as once per day, once per power cycle, once per polishing cycle, etc.). In some embodiments, calibration 234 may also calibrate a degree of force applied by the conditioning device 212 through the tool 234. In some embodiments, calibration 234 may include calibrating the speed at which the control device 212 spins the tool 234. Various computing devices and systems making use of this calibration data will be described in greater detail later in this specification.

### Example Imaging and Planning

In some embodiments, the system 100 may use an imaging device for planning and/or analysis associated with the conditioning process. For example, the system 100 and/or individual apparatus(es) 200 may comprise an imaging device (e.g., the handling device 112 may comprise the imaging device), which may locate a position of the user device 110 and one or more components of the system 100. In some embodiments, the imaging device may use blob and/or edge find tools to locate a position of the user device 110 and one or more components of the system 100. In some embodiments, various parameters of the user device 110 (e.g., make, model, surface (top or bottom), polish region (e.g., whole, half, quadrant, or other region), and/or severity (e.g., degree of conditioning needed) may be manually entered by a user (e.g., via a touch screen, keyboard, or other input/output device) and/or captured and detected by an imaging device and associated computing system. In some embodiments, the imaging device may be a scanner configured to scan an identifier of the user device 110 (e.g., a barcode) to determine one or more of the aforementioned parameters. In some embodiments, the system 100 may be configured to receive an IMEI or other identifier and query one or more databases for conditioning process executable instructions, which may then be executed by the system based on the device identifier. In some embodiments, the imaging device may analyze one or more portions of the system/apparatus and/or facilitate planning of the conditioning process by one or more computing devices.

For example, in some embodiments, the imaging device may be configured to capture images of a user device, and a computing device (e.g., via one or more processors) may be configured to analyze the image to determine one or more parameters associated with the mobile device (e.g., make, model, size, shape, color, etc.) and/or one or more indications of damage associated with the mobile device (e.g., a screen condition, such as low, medium, or high damage). In some embodiments, the computing device may analyze the images using a computational neural network, or another image analysis tool, to determine any one or more such parameters and/or indications of damage. In some embodiments, the computing device may be configured to compare the captured images with one or more prior images (e.g., aggregated images from past conditioning processes), such as via the aforementioned neural network, to determine any one or more such parameters and/or indications of damage. For example, a machine learning model may be trained to detect such parameters and/or indications of damage using historical image data from past conditioning processes (e.g., via structured learning).

Such analysis may be configured to guide the conditioning process. For example, in some embodiments, parameter(s) comprising an identity of the user device (e.g., an “iPhone® X” identity) and/or physical characteristics of the user device (e.g., a “mobile phone having a 6 inch screen” characteristic) may be used by the computing device(s) to plan and execute the conditioning. For example, the size of the user device (e.g., as determined from the identity data and/or physical characteristic data) may be used by the computing device(s) to determine placement of the actuatable supports 208C-D of the platform 204. In some embodiments, indications of damage may be used to determine the extent and/or sequence of the conditioning steps. For example, a user device with “high damage” (e.g., determined via a neural network relative to past conditioning processes and/or devices) may be polished by the conditioning device for longer, harder (e.g., more downward pressure and/or faster polishing speed), with a more abrasive tool, and/or with a more abrasive compound than a user device with “low damage”. In some embodiments, the system 100 may be pre-set with model-specific profiles that may be replicated one or more times (e.g., one, two, or three times) depending on the degree of conditioning required (e.g., grading the device and/or detecting the severity of the device damage). In some embodiments, a model for determining the damage level may be trained, for example, by adjusting the aforementioned parameters when polishing a user device and labeling the resulting data based on the minimum parameters necessary to return the surface of the user device (e.g., the screen area) to a new or like new condition substantially or entirely free of surface abrasion. In some embodiments, the condition of the device may be assessed using various known imaging processes, such as those described in U.S. Pat. No. 11,580,627, entitled “Systems and methods for automatically grading pre-owned electronic devices” and U.S. Pat. No. 10,332,249 entitled “Screen damage detection for devices”, each of which is incorporated by reference herein in its entirety.

In some embodiments, the imaging device may be configured to capture the images of the user device and process them for position and orientation information. For example, the imaging device may be used to detect a location and orientation of a user device on a conveyor, and subsequently, the computing device(s) may guide the end effector 114 to the detected location of the user device as part of a motion planning process. In some embodiments, the motion planning process may additionally or alternatively include detecting the position of one or more other components in the system, such as a location of a platform (e.g., platform 204) of an apparatus (e.g., apparatus 200) for aligning the user device with the platform and/or a location of a conveyor for removing the user device once the conditioning process is complete. In some embodiments, the computing device(s) may additionally or alternatively detect the orientation of the user device (e.g., angular position, which side is facing up, etc.) as part of a motion planning process. The computing device(s) may be configured to rotationally align the user device with the platform (e.g., with the supports 208A-D and/or receiving component 206) to engage the platform in a predetermined orientation. In such embodiments, the end effector 114 may comprise a rotational positioning component (e.g., a servo) configured to rotate the user device while being held. In some embodiments, the computing device(s) may use the image data to determine when an apparatus is or is not installed in the respective bays of the housing 102.

### Example Methods for Conditioning a User Device

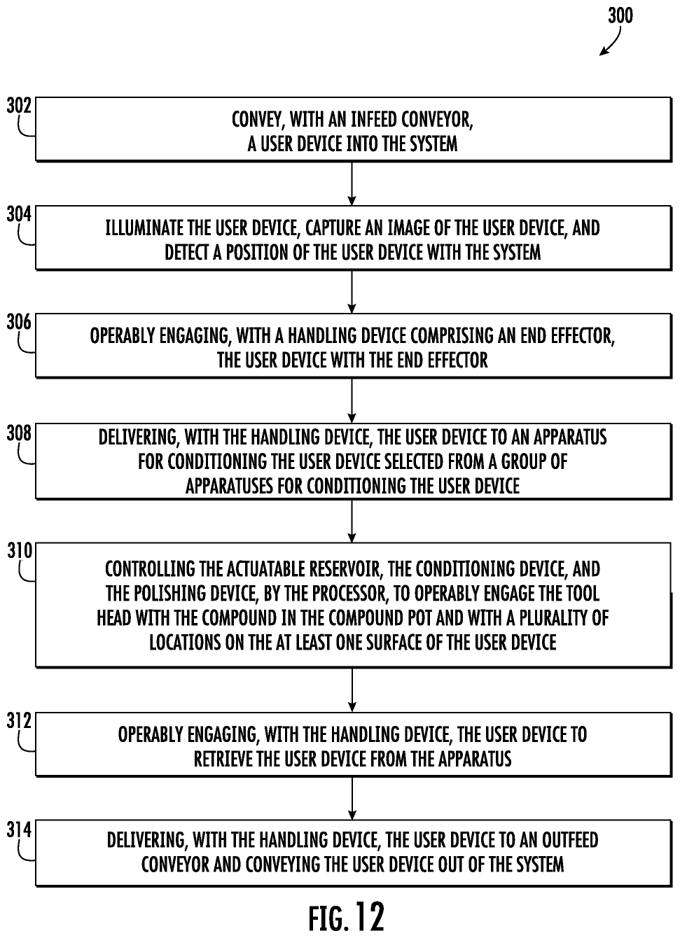

FIG. 12 is an example flow diagram illustrating an example method 300 for conditioning an example user device 110. The example method 300 may be performed using the system 100 and apparatus 200 and the various components and assemblies of each, as previously described. However, it will be understood that the method 300 may be performed using other suitable systems, apparatuses, and components. Moreover, although depicted as a complete method from infeed conveyance to outfeed conveyance, the method may be claimed and described in any number of discrete sub-steps centered around one or more of the individual functions described therein. In some embodiments, one or more steps may be directed by one or more computing device(s) instructing the respective components according to a set of stored computer executable instructions run by processors associated with the computing device(s), which computing device(s) may subsequently cause the respective components to operate according to the instructions. The various processes described herein may be carried out by hardware, software, or a combination of hardware and software.

In the depicted embodiment, the method 300 include a step 302 of conveying a user device (e.g., user device 110) into the system (e.g., system 100), such as with one or more infeed conveyors (e.g., conveyors 106 and/or 108). Optionally, step 302 may be used in an instance in which a conditioning apparatus (e.g., apparatus 200) is associated with a centralized system (e.g., central handling system 140) and the user device is conveyed into a position that the handling device(s) (e.g., handling device 112) is able to interact with the user device.

The method 300 may include a step 304 of illuminating the user device (e.g., forelighting the user device and/or backlighting the user device with a transparent conveyor assembly 108 with backlighting), capturing an image of the user device (e.g., with imaging device 128), and detecting (e.g., with master control system 124) a position of the user device. This position may be input to the master control system 124 or other controlling system or directing the handling device to the user device and/or planning one or more subsequent conditioning steps. Optionally, step 304 may be omitted or combined or replaced with physical location means, such as a bumper, for ensuring a consistent retrieval location of the user device.

In some embodiments, the method 300 may include a step 306 of operably engaging, with the handling device (e.g., handling device 112) comprising the end effector, the user device (e.g., user device 110) with the end effector (e.g., end effector 114). In some embodiments, the method 300 may include another step 308 of delivering, with the handling device, the user device to an apparatus (e.g., apparatus 200) for conditioning the user device. In some embodiments, the handling device move as a three-axis gantry as discussed herein.

In some embodiments, the apparatus may be selected from a group of apparatuses for conditioning the user device. In some embodiments, the method 300 may include another step 310 of controlling the actuatable reservoir (e.g., actuatable reservoir 220), the conditioning device, and the polishing device, by the processor, to operably engage the tool head with the compound in the compound pot and with a plurality of locations on the at least one surface of the user device.

In some embodiments, the method 300 may include additional steps for conditioning an example user device 110. In some embodiments, an additional step may include controlling the positioning assembly and the conditioning device to move the conditioning device with respect to the apparatus to select a new tool having a new tool head. In some embodiments, an additional step may include using the new tool head to clean the compound from the surface of the user device after the compound has been applied and used to condition the user device. In some embodiments, an additional step may include calibrating the positioning assembly and/or the conditioning device using the calibration station on the assembly. These additional steps may be performed in one or more sequences and should not be limited to the order described herein.

Method 300 may optionally include one or more steps for removing the user device from the apparatus (e.g., apparatus 200) and/or the system (e.g., system 100) when conditioning is complete. For example, the method 300 may include a step 312 for operably engaging, with the handling device (e.g., handling device 112, such as with end effector 114), the user device (e.g., user device 110) to retrieve the user device from the apparatus. The method 300 may include a step 314 for delivering, with the handling device (e.g., handling device 112), the user device to one or more outfeed conveyors (e.g., conveyor 104) to convey the user device out of the system. In some embodiments, other handling and/or conveyance devices may be used.

Various computing devices and software configured to execute the preceding method steps will now be described.

### Example Computing Devices

The various operations and methods previously described in this disclosure may be embodied in the following example computing devices and software. According to various embodiments, the system 100 may include at least one non-transitory computer readable medium including computer program code configured to be executed by one or more processors.

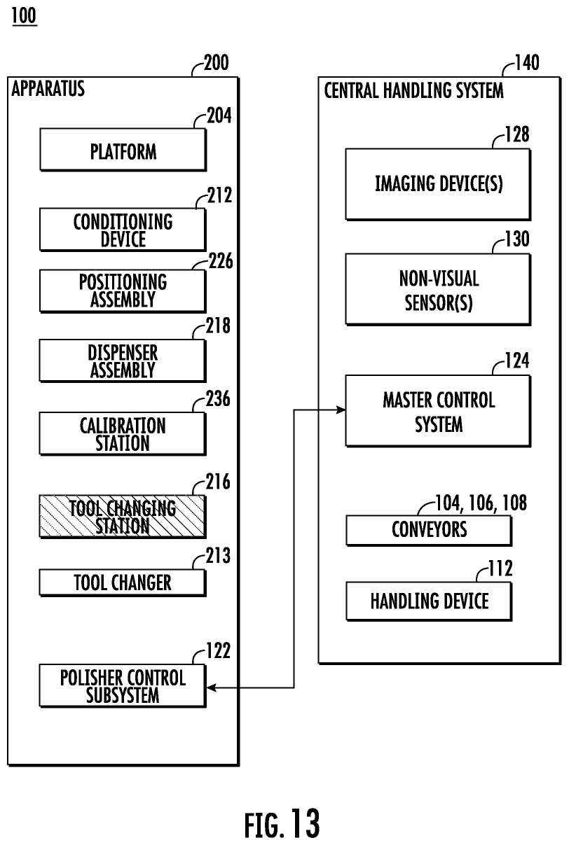

FIG. 13 is an example schematic representation of example hardware, computer, and software components in an example conditioning system 100, including a central handling system 140 and example conditioning apparatus 200 in accordance with various embodiments of the present disclosure. In particular, FIG. 13 illustrates example data communications between various components of the example central handling system 140 and the conditioning apparatus 200, including example components and assemblies of the central handling system 140 and conditioning apparatus 200. The example computer and software components illustrated in FIG. 13 may at least in part define the autonomous system described herein.

In the example shown in FIG. 13, the example central handling system 140 comprises a master control system 124, which can exchange data and/or information with other various devices, systems, and components. Although depicted as a single conditioning system 100, it will be appreciated that the functions of the system 100 can be divided across multiple systems and/or devices, including, but not limited to, into the depicted central handling system 140 and apparatus 200 and can be divided further into any number of separate systems and sub-systems configured to fulfill the purposes and carry out the functionalities disclosed herein. Without limitation, such division may include separating apparatus and overall system processing (e.g., each apparatus may include its own system for monitoring and controlling apparatus operation, while an overall system computing device transmits instructions to and receives data from the individual apparatus systems). It will further be appreciated that the various separate components, assemblies, systems, and subs-systems of the central handling system 140 and the conditioning apparatus 200 may be interchanged and/or shared between each other according to various additional example system architectures not shown in FIG. 13 but embodied in this disclosure. Moreover, the system 100 may be modularly configured to connect to, communicate with, and facilitate the functionality of a plurality of apparatuses 200 (e.g., as shown in FIGS. 1-2).

In some embodiments, the imaging device 128 may be associated with the system 100 via the central handling system 140 and/or the apparatus 200 and may be configured to capture one or more images of the system (e.g., platform 204, conveyors, handling devices, and the like). In some embodiments, the imaging device 128 may generate imaging data (e.g., by taking a photograph or scanning a user device) and transmit the imaging data to the master control system 124 via the system bus. In particular, the imaging device 128 may be a camera, a scanner, or the like. In some embodiments, the imaging device may be a color or greyscale camera configured to capture color or greyscale image data. In some embodiments, the imaging device 128 may comprise multiple cameras oriented at one or more orientations. In some embodiments, the imaging device 128 may be configured to capture and/or generate 2-D and/or 3-D image data and transmit the 2-D and/or 3-D image data to the master control system 124 via the system bus.

In some embodiments, the imaging device 128 may further generate sensor data for one or more non-visual sensors 130. For example, signals from the calibration sensors, sensors associated with the conditioning device 212 and forces on the tool 214, sensors associated with the doors of the housing 102, and the like may be detectable by the master control system 124, which again may be instantiated as one or multiple computing devices locally with the central handling system 140 or remotely connected.

In some embodiments, the computer program code may be configured to, when executed by a processor, configure the various apparatuses, assemblies, and components of the system 100 (e.g., the central handling system 140) to analyze the one or more images taken by the imaging device 128. In some embodiments, this analysis may facilitate the system 100 to motion plan the conditioning device 212, the positioning assembly 226, the dispenser assembly 218, the platform 204, or the like, and/or to perform location recognition for the user device 110, and/or to recognize various features of the user device 110 (e.g., recognizing locations that need polishing or sensitive areas that should be avoided by the conditioning device 212, whether recognized in response).

In some embodiments, the master control system 124 may transmit control instructions to various components of the central handling system 140, including the conveyors 104, 106, 108, the handling device 112, the imaging device 128, and/or the non-visual sensor(s) 130 and/or the apparatus 200 via a system bus, wired connection (e.g., Ethernet, serial, USB, or the like), and/or wireless connection. In some embodiments, the master control system 124 may provide data (e.g., make, model, polish region, and/or severity) to the polisher control subsystem 122 so as to facilitate the polisher control subsystem's execution of the operations associated with the devices of the apparatus 200 (e.g., the conditioning device 212, the positioning assembly 226, the dispenser assembly 218, the platform 204, the calibration station 236, the tool changing station 216, and/or the tool changer), such as those depicted in FIG. 13 and described herein with respect to the various components of the apparatus 200.

In some embodiments, the system bus may be in various forms. For example, the system bus may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the system bus may be configured to communicate via wireless external communication networks using any of a variety of protocols, such as general packet radio service (GPRS), Universal Mobile Telecommunications System (UMTS), Code Division Multiple Access 1900 (CDMA1900), CDMA1900 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), Institute of Electrical and Electronics Engineers (IEEE) 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The master control system 218 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

In some embodiments, one or more components of the system 100, including the apparatus 200, such as the tool changing station 216, may be physically part of one or more subsections of the system 100 without being directly electronically controllable.

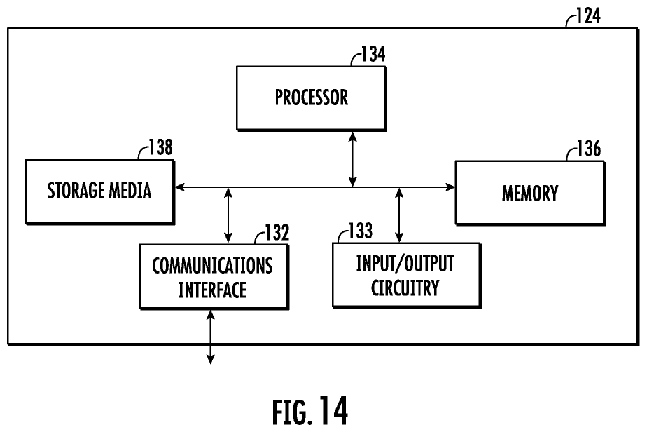

FIG. 14 provides a schematic diagram of the master control system 124 according to some embodiments of the present disclosure. In some embodiments, the polisher control subsystem 122 may include a similar or identical schematic structure for facilitating its corresponding functions. In general, the terms computing entity, entity, device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein.

As indicated, in one embodiment, the master control system 124 may also include one or more network and/or communications interface 132 for communicating with various computing entities, such as by communicating data, content, information, and/or similar terms used herein that can be transmitted, received, operated on, processed, displayed, stored, and/or the like. For instance, the master control system 124 may communicate with other components of the conditioning system 100 or conditioning apparatus(es) (e.g., apparatuses 200A-D shown in FIGS. 1-2). While a single master control system 124 is shown in FIGS. 13-14 for ease of illustration and understanding, in some embodiments, multiple master control systems 124 may be used for one or more portions of the system, apparatus(es), and/or functionalities described herein. In such embodiments, the master control systems may each be connected to the respective other devices, components, and systems necessary to perform their assigned functions and may be configured to control and perform their respective functions as described herein.

As shown in FIG. 14, in one embodiment, the master control system 124 may include or be in communication with one or more processors (for example, processor 134) (also referred to as processing element, processing circuitry, and/or similar terms used herein interchangeably) that communicate with other elements within the master control system 124 via a bus, for example, and/or network connection. As will be understood, the processor 134 may be embodied in a number of different ways. For example, the processor 134 may be embodied as one or more complex programmable logic devices (CPLDs), microprocessors, multi-core processors, coprocessing entities, application-specific instruction-set processors (ASIPs), and/or controllers. Further, the processor 134 may be embodied as one or more other processing devices or circuitry. The term circuitry may refer to an entirely hardware embodiment or a combination of hardware and computer program products. Thus, the processor 134 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processor 305 may be configured for a particular use or configured to execute instructions stored in volatile or non-volatile media or otherwise accessible to the processor 134. As such, whether configured by hardware or computer program products, or by a combination thereof, the processor 134 may be capable of performing steps or operations according to embodiments of the present disclosure when configured accordingly.

In one embodiment, the master control system 124 may further include or be in communication with volatile media (also referred to as volatile storage, memory, memory storage, memory circuitry and/or similar terms used herein interchangeably), which may communicate with the processor 134. In one embodiment, the volatile storage or memory may also include one or more memory 136 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory 136 may be used to store at least portions of the databases, database instances, database management system entities, data, applications, programs, program modules, scripts, source code, object code, byte code, compiled code, interpreted code, machine code, executable instructions, and/or the like being executed by, for example, the processor 134 as shown in FIG. 14. Thus, the databases, database instances, database management system entities, data, applications, programs, program modules, scripts, source code, object code, byte code, compiled code, interpreted code, machine code, executable instructions, and/or the like may be used to control certain aspects of the operation of the master control system 124 with the assistance of the processor 134 and operating system.

In one embodiment, the master control system 124 may further include or be in communication with non-volatile media (also referred to as non-volatile storage, memory, memory storage, memory circuitry and/or similar terms used herein interchangeably), which may communicate with the processor 134. In one embodiment, the non-volatile storage or memory may include one or more non-volatile storage or storage media 138 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or storage media 138 may store databases, database instances, database management system entities, data, applications, programs, program modules, scripts, source code, object code, byte code, compiled code, interpreted code, machine code, executable instructions, and/or the like. The term database, database instance, database management system entity, and/or similar terms used herein interchangeably and in a general sense to may refer to a structured or unstructured collection of information/data that is stored in a computer-readable storage medium.

Storage media 138 may also be embodied as a data storage device or devices, as a separate database server or servers, or as a combination of data storage devices and separate database servers. Further, in some embodiments, storage media 138 may be embodied as a distributed repository such that some of the stored information/data is stored centrally in a location within the system 100 and other information/data is stored in one or more remote locations. Alternatively, in some embodiments, the distributed repository may be distributed over a plurality of remote storage locations only. An example of the embodiments contemplated herein would include a cloud data storage system maintained by a third-party provider and where some or all of the information/data required for the operation of the recovery system may be stored. Further, the information/data required for the operation of the recovery system may also be partially stored in the cloud data storage system and partially stored in a locally maintained data storage system. More specifically, storage media 138 may encompass one or more data stores configured to store information/data usable in certain embodiments.

As indicated, in one embodiment, the master control system 124 may also include one or more network and/or communications interface 132 in communication with the processor 134 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the master control system 124 may be configured to communicate via wireless external communication networks using any of a variety of protocols, such as general packet radio service (GPRS), Universal Mobile Telecommunications System (UMTS), Code Division Multiple Access 1900 (CDMA1900), CDMA1900 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), Institute of Electrical and Electronics Engineers (IEEE) 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The master control system 124 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

In some embodiments, the master control system 124 may include input/output circuitry 133 that may, in turn, be in communication with the processor 134 to provide output to the user and, in some embodiments, to receive an indication of a user input. The input/output circuitry 133 may comprise an interface or the like (e.g., a display rendering a graphical user interface). In some embodiments, the input/output circuitry 133 may include a keyboard, a mouse, a joystick, a touch screen, touch areas, soft keys, a microphone, a speaker, or other input/output mechanisms. The processor 134 and/or input/output circuitry 133 may be configured to control one or more functions of one or more user interface elements through computer program instructions (e.g., software and/or firmware) stored on a memory accessible to the processor (e.g., memory 136).

Many modifications and other aspects of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific aspects disclosed and that modifications and other aspects are intended to be included within the scope of the appended claims. Although specific terms are employed herein, they are used in a generic and descriptive sense only and not for purposes of limitation.

1. An apparatus for conditioning at least one surface of a user device, the apparatus comprising:
a platform configured to support the user device;
a conditioning device configured to engage a tool comprising a tool head;
a dispenser assembly comprising an actuatable reservoir and compound pot, wherein the actuatable reservoir is fluidically coupled with the compound pot to dispense a conditioning compound therein;
a positioning assembly configured to move the conditioning device relative to the user device and the compound pot; and
at least one non-transitory computer-readable medium including computer program code stored thereon that, when executed by at least one processor, configures the apparatus to:
control the actuatable reservoir, the conditioning device, and the positioning assembly to execute at least one conditioning operation to operably engage the tool head with both the compound in the compound pot and with a plurality of locations on the at least one surface of the user device.

2. The apparatus of claim 1, further comprising a calibration tool configured to set a reference position for the positioning assembly, wherein the reference position is relative to one or more of the platform, the tool head, and the dispenser assembly.

3. The apparatus of claim 1, wherein the conditioning device further comprises a tool changer configured to operably engage the tool comprising the tool head.

4. The apparatus of claim 3, wherein the tool changer comprises a chuck.

5. The apparatus of claim 1, wherein the positioning assembly comprises at least one movable frame and at least one actuator, wherein the at least one actuator is configured to operably engage with the movable frame and move relative to the movable frame.

6. The apparatus of claim 5, wherein the movable frame is a three-axis gantry configured to move the conditioning device above the user device.

7. The apparatus of claim 1, wherein the conditioning device is configured to emit a signal when the at least one conditioning operation is complete.

8. The apparatus of claim 1, wherein the conditioning compound is a non-aqueous polishing paste.

9. The apparatus of claim 1, wherein the platform comprises a vacuum table comprising one or more actuators configured to support and hold the user device in a fixed position on the platform.

10. The apparatus of claim 1, wherein the platform comprises one or more movable actuators configured to position and orient the user device into one or more positions and one or more orientations.

11. The apparatus of claim 1, wherein the actuatable reservoir comprises an actuator configured to dispense conditioning compound into the compound pot and the reservoir comprises a syringe actuated by the actuator.

12. The apparatus of claim 1, further comprising a movable cart configured to support one or more of the platform, the conditioning device, the dispenser assembly, and the positioning assembly.

13. The apparatus of claim 1, wherein the plurality of locations comprises at least one sensitive area and wherein the at least one conditioning operation is configured to refrain from operably engaging the tool head with the at least one sensitive area.

14. The apparatus of claim 1, further comprising a polish head changing station, the polish head changing station comprising a cleaning tool configured to clean the user device following application of the compound to the user device.

15. The apparatus of claim 14, wherein the polish head changing station further comprises an actuatable tool mount configured to allow autonomous connection or disconnection with the tool head.

16. A system for conditioning at least one surface of a user device, the system comprising:
a handling device comprising an end effector, wherein the handling device is configured to operably engage the user device with the end effector and deliver the user device to an apparatus for conditioning the user device selected from a group of apparatuses for conditioning the user device, the apparatus for conditioning the user device comprising:
a platform configured to support the user device;
a conditioning device configured to engage a tool comprising a tool head;
a dispenser assembly comprising an actuatable reservoir and compound pot, wherein the actuatable reservoir is fluidically coupled with the compound pot to dispense a conditioning compound therein;
a positioning assembly configured to move the conditioning device relative to the user device and the compound pot; and
at least one non-transitory computer-readable medium including computer program code stored thereon that, when executed by at least one processor, configures the apparatus to:
control the actuatable reservoir, the conditioning device, and the positioning assembly to execute at least one conditioning operation to operably engage the tool head with both the compound in the compound pot and with a plurality of locations on the at least one surface of the user device.

17. The system of claim 16, further comprising an imaging device configured to captured one or more images of the at least one conditioning operation, and wherein the imaging device is configured to transmit the one or more images of the at least one conditioning operation to the at least one non-transitory computer readable medium.

18. The system of claim 17, wherein the computer program code, when executed by the at least one processor, configures the apparatus to do one or more of:
motion plan one or more of the actuatable reservoir, the conditioning device, and
the positioning assembly during the at least one conditioning operation;
perform location recognition for positioning or handling of the user device; and
perform feature recognition for classifying or orienting the user device.

19. The system of claim 17, wherein the computer program code, when executed by the at least one processor, configures the apparatus to use edge and/or blob find tools to analyze the one or more images captured by the imaging device.

20. The system of claim 16, wherein the positioning assembly comprises at least one movable frame and at least one actuator, wherein the at least one actuator is configured to operably engage with the movable frame and move relative to the movable frame.

21. The system of claim 20, wherein the movable frame is a three-axis gantry configured to move the conditioning device above the user device.

22. The system of claim 16, wherein the conditioning device is configured to emit a signal when the at least one conditioning operation is complete.

23. The system of claim 16, wherein the conditioning compound is a non-aqueous polishing paste.

24. The system of claim 16, wherein the platform comprises a vacuum table comprising one or more actuators configured to support and hold the user device in a fixed position on the platform.

25. The system of claim 16, wherein the platform comprises one or more movable actuators configured to position and orient the user device into one or more positions and one or more orientations.

26. The system of claim 16, wherein the actuatable reservoir comprises an actuator configured to dispense conditioning compound into the compound pot and the reservoir comprises a syringe actuated by the actuator.

27. The system of claim 16, further comprising a movable cart configured to support the apparatus for conditioning the user device.

28. The system of claim 16, wherein the plurality of locations comprises at least one sensitive area and wherein the at least one conditioning operation is configured to refrain from operably engaging the tool head with the at least one sensitive area.

29. The system of claim 16, further comprising a polish head changing station, the polish head changing station comprising a cleaning tool configured to clean the user device following application of the compound to the user device.

30. The apparatus of claim 29, wherein the polish head changing station further comprises an actuatable tool mount configured to allow autonomous connection or disconnection with the tool head.

31. A method for conditioning at least one surface of a user device, the method comprising:
operably engaging, with a handling device comprising an end effector, the user device with the end effector;
delivering, with the handling device, the user device to an apparatus for conditioning the user device selected from a group of apparatuses for conditioning the user device, the apparatus for conditioning the user device comprising:
a platform configured to support the user device;
a conditioning device configured to engage a tool comprising a tool head;
a dispenser assembly comprising an actuatable reservoir and compound pot, wherein the actuatable reservoir is fluidically coupled with the compound pot to dispense a conditioning compound therein;
a positioning assembly configured to move the conditioning device relative to the user device and the compound pot;
at least one non-transitory computer-readable medium including computer program code stored thereon that, may be executed by at least one processor; and
controlling the actuatable reservoir, the conditioning device, and a polishing device, by the processor, to operably engage the tool head with the compound in the compound pot and with a plurality of locations on the at least one surface of the user device.

32. The method of claim 31, further comprising removing, by the handling device, the user device from the platform with the end effector.
